(19) United States
(12) Patent Application Publication
(10) Pub. No.: US 2026/0127409 A1
(43) Pub. Date: May 7, 2026

(54) PARTITIONED TRAINING VIA ONE-HOP HISTORICAL GRADIENTS

(71) Applicant: International Business Machines Corporation, Armonk, NY (US)

(72) Inventors: Thanh Lam Hoang, Maynooth (IE); Marcos Martínez Galindo, Dublin (IE); Marco Luca Sbodio, Castaheany (IE); Raúl Fernández Díaz, Dublin (IE); Mykhaylo Zayats, Dublin (IE); Rodrigo Hernan Ordonez-Hurtado, Maynooth (IE); Vanessa Lopez Garcia, Dublin (IE)

(21) Appl. No.: 18/938,713

(22) Filed: Nov. 6, 2024

(51) Int. Cl. G06N 3/042; G06N 3/08

(52) U.S. Cl. CPC G06N 3/042; G06N 3/08

(57) ABSTRACT

Systems/techniques that facilitate partitioned training via one-hop historical gradients are provided. In various embodiments, a system can access a graph. In various aspects, the system can train a graph neural network on partitions of the graph, based on historical gradients of partition-wise training losses with respect to one-hop node embeddings.

### BACKGROUND

The subject disclosure relates to training of graph neural networks.

### SUMMARY

The following presents a summary to provide a basic understanding of one or more embodiments. This summary is not intended to identify key or critical elements, or delineate any scope of the particular embodiments or any scope of the claims. Its sole purpose is to present concepts in a simplified form as a prelude to the more detailed description that is presented later. In one or more embodiments described herein, systems, computer-implemented methods, computer program products, or apparatuses that can facilitate training via one-hop historical gradients are described.

According to one or more embodiments, a system is provided. In various aspects, the system can comprise a processor that can execute computer-executable components stored in a non-transitory computer-readable memory. In various instances, the computer-executable components can comprise an access component that can access a graph. In various cases, the computer-executable components can comprise a training component that can train a graph neural network on partitions of the graph, based on historical gradients of partition-wise training losses with respect to one-hop node embeddings. In various aspects, a first partition of the graph and a second partition of the graph can have a one-hop node, the one-hop node can correspond to an historical gradient value and to an historical gradient count, the historical gradient value can be initially zero, and the historical gradient count can be initially zero. In various instances, while training the graph neural network on the first partition, the training component can add to the historical gradient value of the one-hop node a gradient of a first loss of the first partition with respect to a first embedding of the one-hop node; and can increment the historical gradient count. In various cases, while training the graph neural network on the second partition, the training component can add to the historical gradient value a gradient of a second loss of the second partition with respect to a second embedding of the one-hop node; and can increment the historical gradient count. In various aspects, while training the graph neural network on a third partition to which the one-hop node belongs, the training component can update the graph neural network based on a third loss of the third partition and based on a product between the historical gradient value and a reciprocal of the historical gradient count. In various instances, such training can cause the graph neural network to learn more quickly (e.g., using fewer training epochs) than it could otherwise learn.

In various aspects, the above-described system can be reformulated, reformatted, or otherwise implemented as a computer-implemented method or as a computer program product.

### DESCRIPTION OF THE DRAWINGS

FIG. 1 illustrates a block diagram of an example, non-limiting system that facilitates partitioned training via one-hop historical gradients in accordance with one or more embodiments described herein.

FIG. 2 illustrates a block diagram of an example, non-limiting system including a plurality of partitions, a one-hop historical gradient value registry, and a one-hop historical gradient count registry that facilitates partitioned training via one-hop historical gradients in accordance with one or more embodiments described herein.

FIG. 3 illustrates an example, non-limiting block diagram showing how a graph can be broken into a plurality of partitions in accordance with one or more embodiments described herein.

FIG. 4 illustrates an example, non-limiting block diagram of a one-hop historical gradient value registry and a one-hop historical gradient count registry in accordance with one or more embodiments described herein.

FIGS. 5-9 illustrate example, non-limiting block diagrams showing how a graph neural network can be trained on a partition in accordance with one or more embodiments described herein.

FIGS. 10-13 illustrate example, non-limiting block diagrams showing how a one-hop historical gradient value and a one-hop historical gradient count of a particular node can change during training in accordance with one or more embodiments described herein.

FIGS. 14-17 illustrate flow diagrams of example, non-limiting computer-implemented methods that facilitate partitioned training via one-hop historical gradients in accordance with one or more embodiments described herein.

FIGS. 18-20 illustrate example, non-limiting experimental results in accordance with one or more embodiments described herein.

FIG. 21 illustrates a flow diagram of an example, non-limiting computer-implemented method that facilitates partitioned training via one-hop historical gradients in accordance with one or more embodiments described herein.

FIG. 22 illustrates a block diagram of an example, non-limiting operating environment in which one or more embodiments described herein can be facilitated.

### DETAILED DESCRIPTION

The following detailed description is merely illustrative and is not intended to limit embodiments or application or uses of embodiments. Furthermore, there is no intention to be bound by any expressed or implied information presented in the preceding Background or Summary sections, or in the Detailed Description section.

One or more embodiments are now described with reference to the drawings, wherein like referenced numerals are used to refer to like elements throughout. In the following description, for purposes of explanation, numerous specific details are set forth in order to provide a more thorough understanding of the one or more embodiments. It is evident, however, in various cases, that the one or more embodiments can be practiced without these specific details.

A graph neural network (GNN) can be a type of artificial neural network that is configured to operate on graph data structures (e.g., on collections of nodes and edges). More specifically, a node of any given graph can be considered as representing any suitable entity, object, or thing, and an edge of the given graph can be considered as representing any suitable relationship between any two nodes. It should be understood that the graph can be written or formatted in any suitable fashion, such as via an adjacency matrix or an edge list. Each node of the given graph can have or otherwise be tagged with a respective numerical attribute or feature. Likewise, each edge of the graph can have or otherwise be tagged with a respective numerical attribute or feature.

In various aspects, a GNN can be configured to receive a graph as input. In some instances, the GNN can be configured to produce as output a respective learned embedding (e.g., latent vector representation) for each node of the inputted graph. In other instances, the GNN can be configured to produce as output as respective learned embedding for each edge of the inputted graph. In some cases, such outputted node embeddings or edge embeddings can be fed to any suitable downstream classification model (also referred to as a classification head), so as to generate any suitable node-level classification labels (e.g., a respective classification label for each node), any suitable edge-level classification labels (e.g., a respective classification label for each edge), or any suitable graph-level classification label (e.g., a respective classification label for the entire graph).

In order for the GNN to accurately or reliably perform whatever inferencing task it is configured to perform (e.g., node embedding generation, edge embedding generation), the GNN should first be trained. Oftentimes, the graphs on which it is desired to train the GNN can be extremely large. Indeed, such graphs are often so large (e.g., having millions upon millions of nodes or edges) as to exceed the processing or memory capacities of whatever computing hardware hosts the GNN. So, such graphs are often partitioned into smaller subgraphs, each of which can fit within the processing or memory capacities of the computing hardware that hosts the GNN, and the GNN can then be trained on each of those smaller subgraphs individually.

When such partitioned training is performed in a naïve fashion, significant loss of information can ensuc. After all, the GNN can contain various types of graph convolutional layers or message passing layers that compute embeddings for certain nodes (or edges) based not only on the features or attributes of those certain nodes (or edges), but also based on whatever other nodes (or edges) are neighbors of those certain nodes (or edges). However, some neighbors of those certain nodes might not be within the same partitions as those certain nodes. In some cases, such different-partition neighbors can be referred to as one-hop nodes, since they are one edge, or hop, away notwithstanding being in different partitions. Naively training the GNN on each individual partition can be considered as ignoring one-hop nodes, which can prevent the GNN from being trained properly.

Existing techniques attempt to address such challenge via an approach called GNNAutoScale (GAS). Such existing techniques track or record whatever embeddings respective layers of the GNN produce for each node. These can be referred to as historical embeddings. So, when being trained on any given partition, the GNN can have access not just to the attributes or features of the nodes in that given partition, but the GNN can also have access to the historical embeddings that the intermediate layers of the GNN previously produced for any one-hop nodes of that given partition. In this way, the GNN can be trained without ignoring one-hop nodes.

However, the inventors of various embodiments described herein recognized that such existing techniques suffer from a noteworthy disadvantage. Specifically, the present inventors realized that, for any given partition, GAS utilizes embeddings of one-hop nodes that were acquired while optimizing the training objective functions of other partitions and not of the given partition. The present inventors recognized that this causes GAS to converge more slowly than is desirable (e.g., causes GAS to require more training epochs than is desirable).

The present inventors devised various embodiments described herein, which can help to address or ameliorate the above-described technical problems that plaque existing techniques for training GNNs. In particular, the present inventors realized that the recording or tracking of historical embeddings in GAS can be supplemented with recording or tracking of gradients (e.g., partial derivatives) of partition-wise losses with respect to embeddings. For any given node, such a gradient can be computed or updated when that given node serves or qualifies as a one-hop node for whatever partition is currently being used to train a GNN, and such gradient can be used to perform an additional parameter update on the GNN when that given node is within whatever partition is currently being used to train the GNN. In other words, various embodiments described herein can involve not just utilization of historical embeddings of one-hop nodes, but also utilization of historical loss-to-embedding gradients of one-hop nodes. When the GNN is trained in such fashion, significantly faster training convergence can be achieved.

Accordingly, various embodiments described herein can be considered as concrete technical improvements in GNN training.

Various embodiments described herein can be considered as a computerized tool (e.g., any suitable combination of computer-executable hardware or computer-executable software) that can facilitate partitioned training via one-hop historical gradients. In various aspects, such a computerized tool can comprise an access component, a training component, or an execution component.

In various embodiments, there can be a particular graph. In various aspects, the particular graph can be made up of any suitable number of nodes and any suitable number of edges. In various instances, each node or each edge of the particular graph can have any suitable numerical feature or attribute of any suitable format, size, or dimensionality (e.g., each node or edge can have a respective scalar attribute; each node or edge can have a respective vector attribute).

In various cases, there can be a GNN. In various aspects, the GNN can exhibit any suitable deep learning internal architecture. For example, the GNN can include any suitable numbers of any suitable types of layers (e.g., input layer, one or more hidden layers, output layer, any of which can be graph convolutional layers, message passing layers, dense layers, long short-term memory (LSTM) layers, non-linearity layers, pooling layers, batch normalization layers, or padding layers). As another example, the GNN can include any suitable numbers of neurons in various layers (e.g., different layers can have the same or different numbers of neurons as each other). As yet another example, the GNN can include any suitable activation functions (e.g., softmax, sigmoid, hyperbolic tangent, rectified linear unit) in various neurons (e.g., different neurons can have the same or different activation functions as each other). As still another example, the GNN can include any suitable interneuron connections or interlayer connections (e.g., forward connections, skip connections, recurrent connections).

Regardless of its specific internal architecture, the GNN can be configured to perform any suitable inferencing task on inputted graphs. As some non-limiting examples, the GNN can be configured to produce node-wise embeddings for an inputted graph, edge-wise embeddings for an inputted graph, node-wise classifications for an inputted graph, edge-wise classifications for an inputted graph, or a graph-level classification for an inputted graph.

In any case, it can be desired to train the GNN on the particular graph. As described herein, the computerized tool can facilitate such training.

In various embodiments, the access component of the computerized tool can electronically access, via any suitable wired or wireless electronic connections, the GNN. In various instances, the access component can further access or otherwise receive, retrieve, or import from any suitable source the particular graph. In any case, the access component can access the GNN or the particular graph, such that other components of the computerized tool can electronically interact with (e.g., initialize, execute, modify) the GNN or can electronically interact with (e.g., read, write, edit, copy, manipulate) the particular graph.

In various embodiments, the training component of the computerized tool can electronically train the GNN on the particular graph. In various aspects, the training component can accomplish such training by breaking the particular graph up into a plurality of partitions and by leveraging a one-hop historical gradient value registry and a one-hop historical gradient count registry.

In various instances, the plurality of partitions can include any suitable number of partitions. In various cases, each partition can be a subgraph of the particular graph. That is, each partition can include any suitable subset of the nodes and edges of the particular graph. In some aspects, the plurality of partitions can be disjoint or non-overlapping with each other. That is, each node in the particular graph can belong to exactly one partition. However, in other aspects, the plurality of partitions can instead be non-disjoint or overlapping with each other. That is, any given node in the particular graph can, but need not, belong to more than one partition. In any case, the union of the plurality of partitions can be equivalent to the particular graph.

In various aspects, the one-hop historical gradient value registry can be any suitable electronic database or data structure that contains a respective one-hop historical gradient value for each node of the particular graph. In various instances, a one-hop historical gradient value can be any suitable scalar that is initialized at 0 and that represents a cumulative loss-to-embedding gradient of a respective node of the particular graph. In various cases, the training component can update the one-hop historical gradient value for any given node, by performing a push-add operation when that given node is a one-hop node of whatever partition the GNN is currently being trained on (e.g., when that given node does not belong to the current partition but shares an edge with at least one node in the current partition).

In various aspects, the one-hop historical gradient count registry can be any suitable electronic database or data structure that contains a respective one-hop historical gradient count for each node of the particular graph. In various instances, a one-hop historical gradient count can be any suitable scalar that is initialized at 0 and that represents how many times the one-hop historical gradient value of a respective node has been updated via a push-add operation. In various cases, the training component can increment the one-hop historical gradient count of any given node by 1 each time the training component performs a push-add operation on whatever one-hop historical gradient count corresponds to the given node.

In various aspects, the training component can leverage the one-hop historical gradient value registry and the one-hop historical gradient count registry in conjunction with the plurality of partitions, so as to train the GNN.

As a non-limiting example of such training, consider a partition X. In various aspects, the training component can electronically execute the GNN on the partition X. More specifically, the computerized tool can feed to the input layer of the GNN whatever features or attributes correspond to the nodes or edges of the partition X, those features or attributes can complete a forward pass through the one or more hidden layers of the GNN, and the output layer of the GNN can compute an inferencing task result (e.g., node-wise embeddings, node-wise classification labels, edge-wise embeddings, edge-wise classification labels, graph-level classification label) based on activations provided by the one or more hidden layers.

Now, suppose that the partition X has a one-hop node Y. In such case, the training component can utilize the GAS approach during execution of the GNN on the partition X. That is, whatever embeddings were previously produced by hidden layers of the GNN for the one-hop node Y can be recalled (e.g., from any suitable historical embedding registry) and can be fed to appropriate or respective layers of the GNN as the features or attributes of the partition X are completing their forward pass through the GNN. Accordingly, the inferencing task result produced by the GNN can be based not only on the features or attributes of the partition X, but also on the historical embeddings of the one-hop node Y.

The training component can, in various aspects, compute a loss for the partition X. For instance, such loss can be equal to or otherwise based on any suitable error (e.g., mean absolute error (MAE), mean squared error (MSE), cross-entropy error) between: the inferencing task result; and a ground-truth inferencing task result that is known or deemed to correspond to the partition X. In various aspects, the training component can apply backpropagation (e.g., stochastic gradient descent) on such loss, thereby yielding a first update for the parameters of the GNN.

In various instances, the training component can compute a gradient or partial derivative of: the loss associated with the partition X; with respect to the current or most-recent embedding of the one-hop node Y. In various cases, the training component can update the one-hop historical gradient value registry by push-adding such gradient or partial derivative to whatever one-hop historical gradient value corresponds to the one-hop node Y (e.g., by adding the gradient or partial derivative to whatever current or present-time magnitude that one-hop historical gradient value has). In response to push-adding the one-hop historical gradient value of the one-hop node Y, the training component can update the one-hop historical gradient count registry by incrementing whatever one-hop historical gradient count corresponds to the one-hop node Y (e.g., by adding 1 to whatever current or present-time magnitude that one-hop historical gradient count has).

In various aspects, the training component can compute a second update for the parameters of the GNN, based on whatever one-hop historical gradient values and whatever one-hop historical gradient counts correspond to the nodes of the partition X. More specifically, for each node in the partition X, the training component can: compute a partial derivative of the current or most recent embedding of that node with respect to the learnable parameters of the GNN; and multiply that partial derivative by whatever one-hop historical gradient value corresponds to that node and by a reciprocal of whatever one-hop historical gradient count corresponds to that node. This can yield a respective multiplicative product for each node of the partition X. In various cases, the second update can be equal to or otherwise based on any suitable aggregation (e.g., any suitable weighted or unweighted sum or average) of such multiplicative products. In various instances, the training component can then reset to zero all of the one-hop historical gradient values and all of the one-hop historical gradient counts that correspond to the nodes of the partition X.

In various aspects, the training component can perform both the first update and the second update on the GNN. This can cause the learnable parameters of the GNN to be incrementally changed so as to increase an inferencing task accuracy or reliability of the GNN. In particular, the first update can be considered as changing (e.g., increasing or decreasing) the GNN's parameters based on how well or how poorly the GNN has analyzed the nodes of the partition X with respect to the loss of the partition X. In contrast, the second update can be considered as changing the GNN's parameters based on how well or poorly the GNN had previously analyzed the nodes of the partition X with respect to the losses of other partitions in the plurality of partitions (e.g., some nodes of the partition X might be one-hop nodes of other partitions).

Such execution-and-update procedure can be repeated any suitable number of times (e.g., one or more times for each partition). This can ultimately cause the learnable parameters of the GNN to become iteratively optimized for accurately or reliably performing its inferencing task on inputted graph structures.

In various embodiments, after the GNN has been trained, the execution component of the computerized tool can deploy the GNN in any suitable operational context so as to perform the inferencing task on graphs that have no corresponding ground-truths. As a non-limiting example, the execution component can electronically access, receive, retrieve, or obtain any suitable other graph (e.g., or any suitable partition thereof) and can electronically execute the now-trained GNN on that other graph. Such execution can yield an inferred or predicted inferencing task result for the other graph (e.g., inferred or predicted node-wise embeddings, inferred or predicted edge-wise embeddings, inferred or predicted node-wise classification labels, inferred or predicted edge-wise classification labels, inferred or predicted graph-level classification label). In various cases, the execution component can electronically transmit the inferred or predicted inferencing task result to any other suitable computing device, or can electronically render the inferred or predicted inferencing task result on any suitable electronic display or computer screen.

Various embodiments described herein can be employed to use hardware or software to solve problems that are highly technical in nature (e.g., to facilitate partitioned training via one-hop historical gradients), that are not abstract and that cannot be performed as a set of mental acts by a human. Further, some of the processes performed can be performed by a specialized computer (e.g., deep learning neural networks that are configured to operate on graph data structures).

In various aspects, some defined tasks associated with various embodiments described herein can include: accessing, by a device operatively coupled to a processor, a graph; and training, by the device, a graph neural network on partitions of the graph, based on historical gradients of partition-wise training losses with respect to one-hop node embeddings. In various instances, a first partition of the graph and a second partition of the graph can have a one-hop node, the one-hop node can correspond to an historical gradient value and to an historical gradient count, the historical gradient value can be initially zero, and the historical gradient count can be initially zero. In various cases, while training the graph neural network on the first partition, the device: can add to the historical gradient value of the one-hop node a gradient of a first loss of the first partition with respect to a first embedding of the one-hop node; and can increment the historical gradient count. In various aspects, while training the graph neural network on the second partition, the device: can add to the historical gradient value a gradient of a second loss of the second partition with respect to a second embedding of the one-hop node; and can increment the historical gradient count. In various instances, while training the graph neural network on a third partition to which the one-hop node belongs, the device: can update the graph neural network based on a third loss of the third partition and based on a product between the historical gradient value and a reciprocal of the historical gradient count. In various cases, the device can reset the historical gradient value to zero and the historical gradient count to zero, in response to updating the graph neural network based on the third loss. In various aspects, such defined acts can further include: executing, by the device and post-training, the graph neural network on another graph, thereby yielding an inferencing task result for the another graph.

Neither the human mind nor a human with pen and paper can: electronically access partitions of a graph data structure; and electronically train a GNN on such partitions by using gradients or derivatives of partition-wise training losses with respect to one-hop node embeddings. After all, artificial neural networks are inherently computerized constructs comprising specific software-oriented architectures (e.g., input layers, hidden layers, or output layers, any of which can be made up of trainable or non-trainable internal parameters such as convolutional layers, message passing layers, or LSTM layers). Artificial neural networks cannot be trained or executed by the human mind, or by humans with mere pen and paper, in any reasonable or practicable way without computers. It would make no sense whatsoever to discuss the field of graph neural network training outside of a computing context. Therefore, a computerized tool that can facilitate partitioned training of graph neural networks via one-hop historical gradients is inherently computerized and cannot be implemented in any sensible, practicable, or reasonable way without computers. In various instances, one or more embodiments described herein can integrate the herein-described teachings into a practical application. As mentioned above, it can be desired to train a GNN on graphs that are too large for given computer memories or processing capacities. To facilitate such training, some existing techniques break such large graphs up into partitions and then independently train the GNN on each partition. Unfortunately, such existing techniques ignore one-hop nodes and thus achieve poor GNN performance. Other existing techniques, such as GAS, attempt to resolve this issue by keeping track of historical embeddings of one-hop nodes. Such other existing techniques avoid catastrophic loss of information, but the present inventors nevertheless realized that such other existing techniques suffer from slow convergence. Specifically, the present inventors realized that such other existing techniques utilize one-hop node embeddings that have been optimized or updated for the training loss functions of other partitions rather than for whatever partition the GNN is currently being trained on.

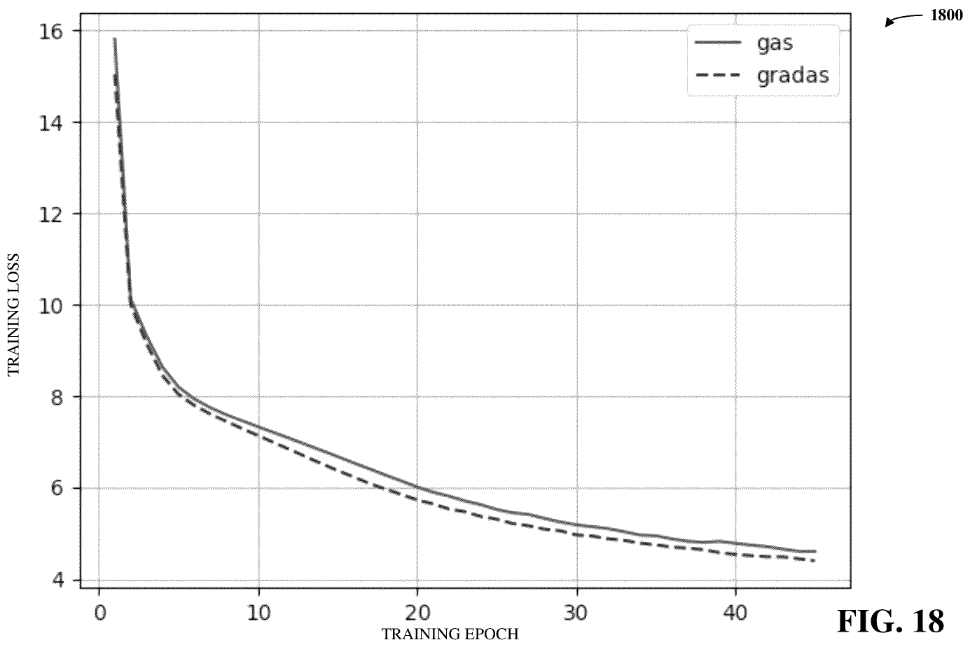

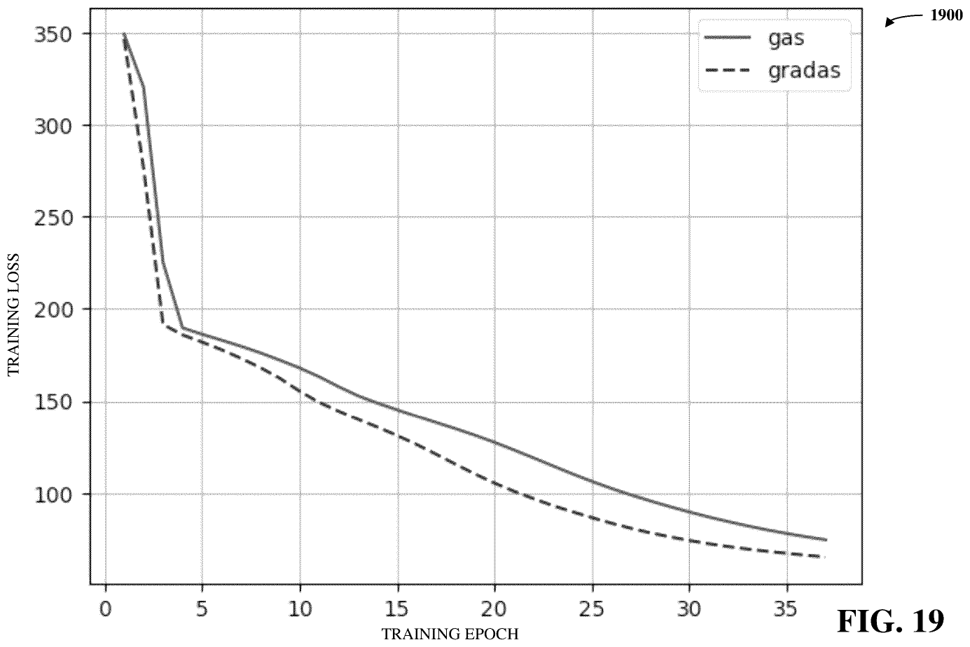

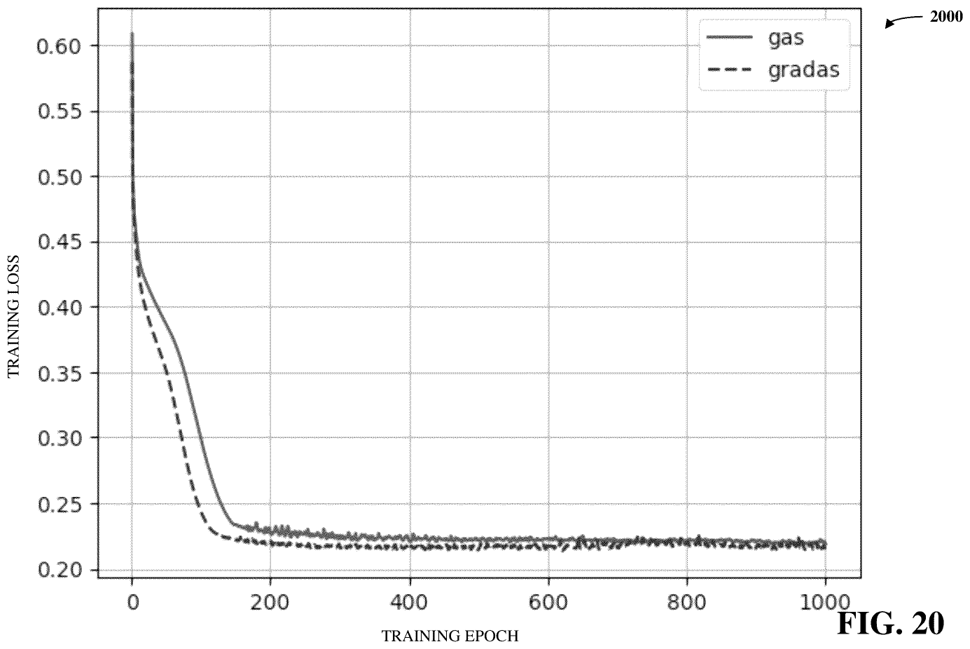

Accordingly, the present inventors devised various embodiments described herein, which can be considered as solving, addressing, or otherwise ameliorating the slow convergence of such other existing techniques. In particular, various embodiments described herein can include keeping track not just of historical embeddings of one-hop nodes, but also of loss-to-embedding gradients of one-hop nodes. Specifically, when it is desired to train a GNN on a graph, various embodiments described herein can involve tracking a respective one-hop historical gradient value and a respective one-hop historical gradient count for each node in the graph, where such values and counts can all be initialized at zero. When the GNN is being trained on any given partition, various embodiments described herein can involve executing the GNN on that given partition as well as on whatever historical embeddings correspond to one-hop nodes of that given partition. Such execution can yield an inferencing task result, and a loss for the given partition can be equal to any suitable error between the inferencing task result and a ground-truth inferencing task result. In various aspects, a first parameter update for the GNN can be computed by applying backpropagation or stochastic gradient descent to that loss. In various instances, various embodiments described herein can involve updating the one-hop historical gradient values of the one-hop nodes of the given partition (e.g., by push-adding to those values respective loss-to-embedding gradients of those one-hop nodes). Various embodiments described herein can also involve updating the one-hop historical gradient counts of the one-hop nodes of the given partition (e.g., by incrementing each of those values by 1). In various cases, various embodiments described herein can involve computing a second parameter update for the GNN, by leveraging whatever one-hop historical gradient values and whatever one-hop historical gradient counts correspond to the nodes of the given partition (e.g., for each node in the given partition, this can involve multiplying the one-hop historical gradient value of that node by the reciprocal of the one-hop historical gradient count of that node and by the partial derivative of the embedding of that node with respect to the parameters of the GNN, thereby yielding a respective product per node of the given partition, and summing all of such products together in weighted or unweighted fashion). Various embodiments described herein can involve resetting to zeros the one-hop historical gradient values and the one-hop historical gradient counts of the nodes of the given partition. In various cases, both the first update and the second update can be performed on the parameters of the GNN. Such training can be repeated for each partition. The present inventors experimentally verified that training the GNN in such fashion yields significantly faster convergence than training the GNN according to existing techniques (e.g., according to GAS by itself), as shown with respect to FIGS. 18-20. For at least these reasons, various embodiments described herein constitute concrete and tangible technical improvements or technical effects in the field of graph neural networks and thus certainly qualify as useful and practical applications of computers.

It should be appreciated that the figures and the herein disclosure describe non-limiting examples of various embodiments. It should further be appreciated that the figures are not necessarily drawn to scale.

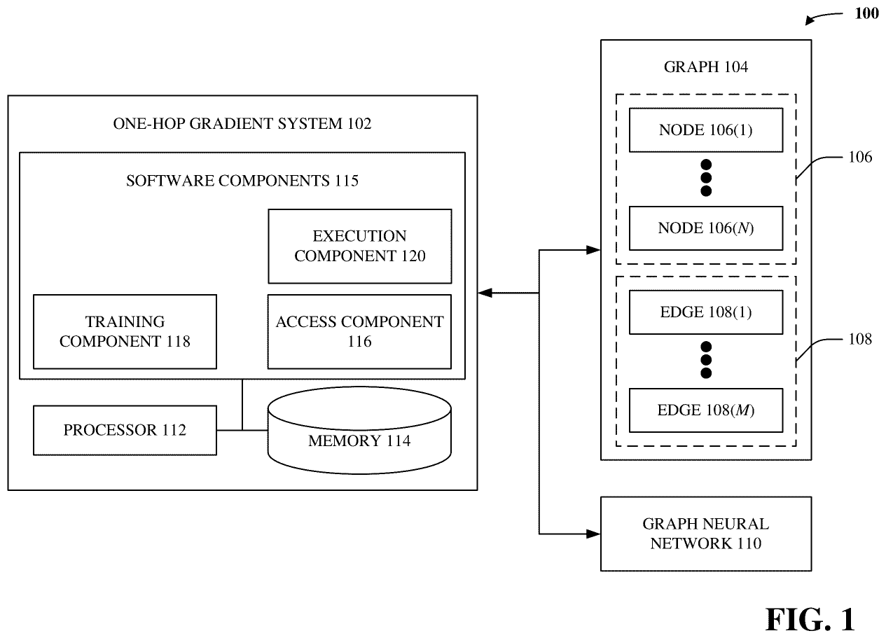

FIG. 1 illustrates a block diagram of an example, non-limiting system 100 that can facilitate partitioned training via one-hop historical gradients in accordance with one or more embodiments described herein. As shown, a one-hop gradient system 102 can be electronically integrated, via any suitable wired or wireless electronic connections, with a graph 104 or with a graph neural network 110 (hereafter “GNN 110”).

In various embodiments, the graph 104 can be any suitable graph data structure. In various aspects, the graph 104 can have, possess, be made up of, or otherwise comprise a plurality of nodes 106 and a plurality of edges 108. In various instances, the plurality of nodes 106 can include n nodes, for any suitable positive integer n>1: a node 106(1) to a node 106(n). In various cases, the plurality of edges 108 can include m edges, for any suitable positive integer m>1: an edge 108(1) to an edge 108(m). In various aspects, each of the plurality of nodes 106 can represent any suitable entity or thing in whatever operational context is associated with the graph 104. In contrast, each of the plurality of edges 108 can represent any suitable directional or non-directional relationship between any two of the plurality of nodes 106.

As a non-limiting example, the graph 104 can represent a biological network. In such case, each of the plurality of nodes 106 can represent a respective protein, gene, or other biological molecule, and each of the plurality of edges 108 can represent a respective chemical or biological interaction (e.g., “antibody of”, “antigen of”, “enzyme of”, “substrate of”) between any two proteins, genes, or other biological molecules.

As another non-limiting example, the graph 104 can represent a computer network. In such case, each of the plurality of nodes 106 can represent a respective computing device or processor, and each of the plurality of edges 108 can represent a respective electronic connection or service interaction (e.g., “server of”, “client of”) between any two computing devices or processors.

As yet another non-limiting example, the graph 104 can represent a transportation network. In such case, each of the plurality of nodes 106 can represent a respective address, building, or geographic location, and each of the plurality of edges 108 can represent a respective travel route between any two addresses, buildings, or geographic locations.

As still another non-limiting example, the graph 104 can represent a social media network. In such case, each of the plurality of nodes 106 can represent a respective social media user or account, and each of the plurality of edges 108 can represent a respective social media relationship (e.g., “friend of”, “family member of”, “following”, “blocked by”) between any two social media users or accounts.

As even another non-limiting example, the graph 104 can be any other suitable type of knowledge graph. In such case, each of the plurality of nodes 106 can represent a respective concept or entity (e.g., person, animal, place, thing), and each of the plurality of edges 108 can represent a respective epistemic relationship (e.g., “is a”, “located in”, “contains”, “consumes”, “bigger than”, “smaller than”) between any two concepts or entities.

No matter what particular things the plurality of nodes 106 represent, each of the plurality of nodes 106 can have, be tagged with, or otherwise correspond to one or more respective numerical features, properties, or attributes having any suitable formats, sizes, or dimensionalities. As a non-limiting example, each of the plurality of nodes 106 can have or exhibit one or more respective scalars, one or more respective vectors, one or more respective matrices, or one or more respective tensors. For instance, the features, properties, or attributes of the node 106(1) can be represented or conveyed by one or more first scalars, vectors, matrices, or tensors, whereas the features, properties, or attributes of the node 106(n) can be represented or conveyed by one or more n-th scalars, vectors, matrices, or tensors.

Likewise, no matter what particular relationships the plurality of edges 108 represent, each of the plurality of edges 108 can have, be tagged with, or otherwise correspond to one or more respective numerical features, properties, or attributes having any suitable formats, sizes, or dimensionalities. As a non-limiting example, each of the plurality of edges 108 can have or exhibit one or more respective scalars, one or more respective vectors, one or more respective matrices, or one or more respective tensors. For instance, the features, properties, or attributes of the edge 108(1) can be represented or conveyed by one or more first scalars, vectors, matrices, or tensors, whereas the features, properties, or attributes of the edge 108(m) can be represented or conveyed by one or more m-th scalars, vectors, matrices, or tensors.

In some cases, the graph 104 can be extremely large. That is, the graph 104 can contain millions, tens of millions, hundreds of millions, or even billions of nodes or edges.

In various aspects, it should be understood or otherwise appreciated that the graph 104 can be written or otherwise formatted according to any suitable syntax or fashion. As a non-limiting example, the graph 104 can be written or formatted as an adjacency matrix. As another non-limiting example, the graph 104 can be written or formatted as an edge list. As yet another non-limiting example, the graph 104 can be written or formatted as an adjacency list. As even another non-limiting example, the graph 104 can be written according to a graph mark-up language (GraphML) format. As still another non-limiting example, the graph 104 can be written according to a JavaScript object notation (JSON) format. As another non-limiting example, the graph 104 can be written according to a resource description framework (RDF) format.

In various embodiments, the GNN 110 can exhibit any suitable deep learning internal architecture. Indeed, in various cases, the GNN 110 can have an input layer, one or more hidden layers, and an output layer. In various instances, any of such layers can be coupled together by any suitable interneuron connections or interlayer connections, such as forward connections, skip connections, or recurrent connections. Furthermore, in various cases, any of such layers can be any suitable types of neural network layers having any suitable learnable or trainable internal parameters. For example, any of such input layer, one or more hidden layers, or output layer can be graph convolutional layers or message passing layers, whose learnable or trainable parameters can be convolutional kernels, message passing weights, or message aggregation weights. As another example, any of such input layer, one or more hidden layers, or output layer can be ChebNet layers, whose learnable or trainable parameters can be Chebyshev coefficients. As yet another example, any of such input layer, one or more hidden layers, or output layer can be dense layers, whose learnable or trainable parameters can be weight matrices or bias values. As still another example, any of such input layer, one or more hidden layers, or output layer can be batch normalization layers, whose learnable or trainable parameters can be shift factors or scale factors. As even another example, any of such input layer, one or more hidden layers, or output layer can be LSTM layers, whose learnable or trainable parameters can be input-state weight matrices or hidden-state weight matrices. As yet another example, any of such input layer, one or more hidden layers, or output layer can be transformer layers, whose learnable or trainable parameters can be single-head or multi-head attention blocks or other weight matrices. Further still, in various cases, any of such layers can be any suitable types of neural network layers having any suitable fixed or non-trainable internal parameters. For example, any of such input layer, one or more hidden layers, or output layer can be non-linearity layers, padding layers, pooling layers, or concatenation layers.

Regardless of its specific internal architecture (e.g., of its specific numbers, types, or organizations of layers), the GNN 110 can be configured to perform any suitable inferencing task on any suitable inputted graphs. In various aspects, the inferencing task can be any suitable type of predictive computation that carries substantive significance in whatever operational context in which the GNN 110 is desired or intended to be deployed or implemented. As a non-limiting example, the inferencing task can be any suitable type of graph regression, such as: node property prediction (e.g., prediction of features, properties, or attributes of respective nodes); edge property prediction (e.g., prediction of features, properties, or attributes of respective edges); node embedding generation (e.g., computation of latent vector representations of respective nodes); edge embedding generation (e.g., computation of latent vector representations of respective edges); or the prediction of any other continuously-variable value associated with an inputted graph. As another non-limiting example, the inferencing task can be any suitable type of classification, such as: node-wise classification (e.g., prediction of classification labels for respective nodes); edge-wise classification (e.g., prediction of classification labels for respective edges); or graph-level classification (e.g., prediction of a classification label for an entire inputted graph).

In various aspects, it can be desired to train the GNN 110 on the graph 104. In some instances, it can be the case that the GNN 110 has not yet received any training whatsoever. But in other instances, it can instead be the case that the GNN 110 has already received at least some training (e.g., on one or more other graphs) and that additional training on the graph 104 is desired. In any case, the one-hop gradient system 102 can facilitate such training as described herein.

In various embodiments, the one-hop gradient system 102 can comprise a processor 112 (e.g., computer processing unit, microprocessor) and a non-transitory computer-readable memory 114 that is operably connected or coupled to the processor 112. The memory 114 can store computer-executable instructions which, upon execution by the processor 112, can cause the processor 112 or other components of the one-hop gradient system 102 (e.g., access component 116, training component 118, execution component 120) to perform one or more acts. In various embodiments, the memory 114 can store computer-executable components (e.g., access component 116, training component 118, execution component 120), and the processor 112 can execute the computer-executable components.

In various embodiments, the one-hop gradient system 102 can comprise an access component 116. In various aspects, the access component 116 can electronically access, in any suitable fashion, the GNN 110, such that the one-hop gradient system 102 can electronically execute, electronically modify (e.g., edit parameters), or otherwise electronically control the GNN 110. Furthermore, in various instances, the access component 116 can electronically receive, retrieve, obtain, import, or otherwise access, from any suitable data structures or from any suitable computing devices, the graph 104, such that the one-hop gradient system 102 can electronically read from or write to the graph 104. In any case, the access component 116 can electronically access (e.g., send or receive data or program instructions to or from) the GNN 110 or the graph 104, such that other components of the one-hop gradient system 102 can electronically interact with the GNN 110 or with the graph 104.

In various embodiments, the one-hop gradient system 102 can comprise a training component 118. In various aspects, the training component 118 can, as described herein, train the GNN 110 on the graph 104 in partitioned fashion, by leveraging a one-hop historical gradient value registry or a one-hop historical gradient count registry.

In various embodiments, the one-hop gradient system 102 can comprise an execution component 120. In various instances, the execution component 120 can, as described herein, deploy or implement the GNN 110 after such training.

Note that, in various instances, the access component 116, the training component 118, and the execution component 120 can collectively be considered as being one or more software components 115 of the one-hop gradient system 102. In various aspects, it should be appreciated that the one or more software components 115 are described primarily herein as comprising three components (e.g., the access component 116, the training component 118, and the execution component 120) for ease of explanation and illustration. However, the one or more software components 115 are not limited to being implemented as exactly such three components in every embodiment. Indeed, in some embodiments, the functionalities described herein of such three components can be combined in any suitable fashions, so as to be implemented in or by fewer than three components (e.g., in some cases, a single component can perform all of the functionalities that are described herein with respect to the access component 116, the training component 118, and the execution component 120). In other embodiments, the functionalities described herein of such three components can instead be distributed, separated, split, or fragmented in any suitable fashions, so as to be implemented in or by more than three components (e.g., two or more components can facilitate the functionalities that are performable by the access component 116; two or more components can facilitate the functionalities that are performable by the training component 118; two or more components can facilitate the functionalities that are performable by the execution component 120).

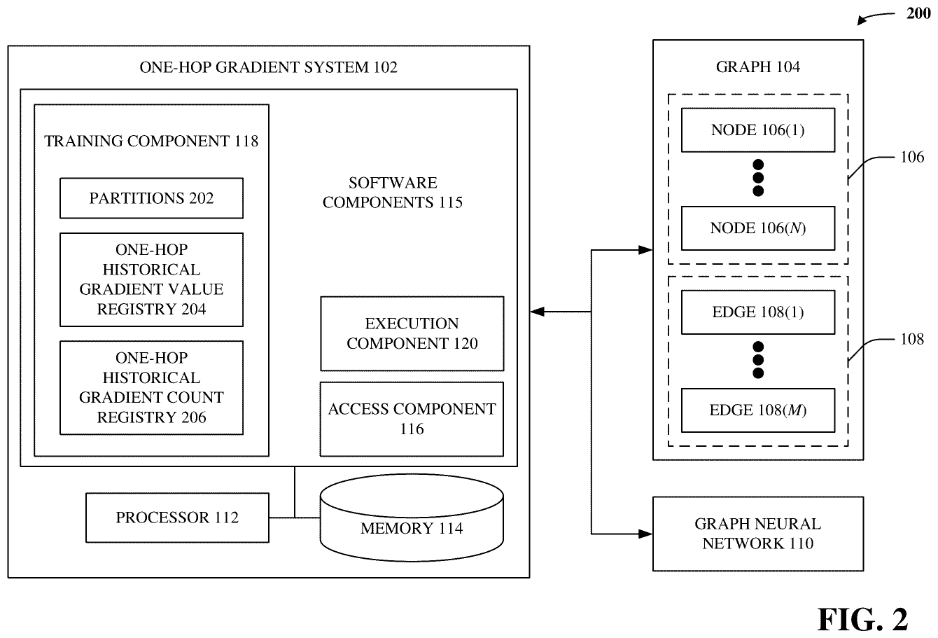

FIG. 2 illustrates a block diagram of an example, non-limiting system 200 including a plurality of partitions, a one-hop historical gradient value registry, and a one-hop historical gradient count registry that can facilitate partitioned training via one-hop historical gradients in accordance with one or more embodiments described herein. As shown, the system 200 can, in some cases, include the same components as the system 100, and can further include a plurality of partitions 202, a one-hop historical gradient value registry 204, or a one-hop historical gradient count registry 206.

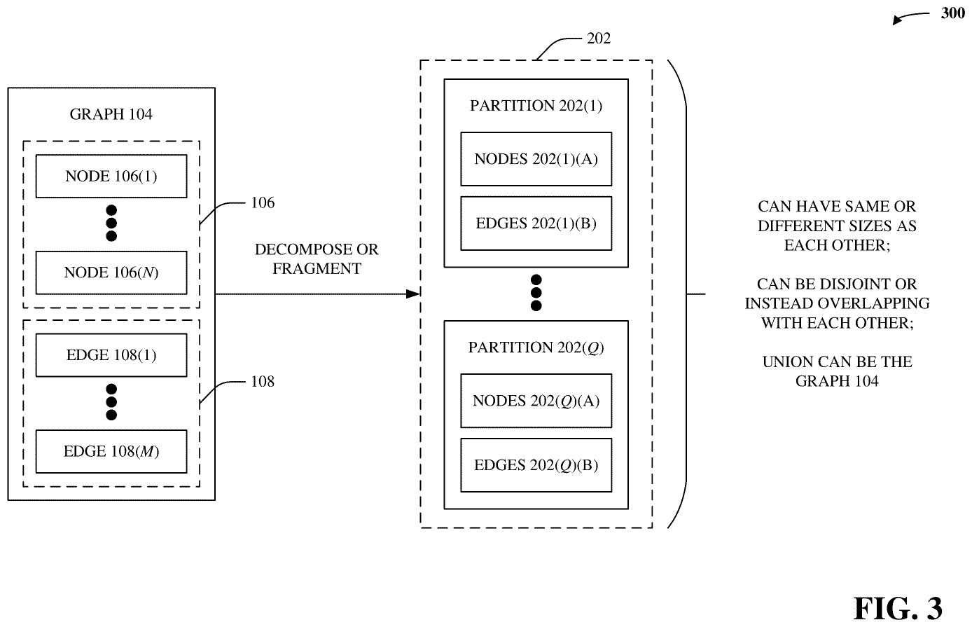

In various aspects, the training component 118 can leverage the plurality of partitions 202, the one-hop historical gradient value registry 204, or the one-hop historical gradient count registry 206, so as to train the GNN 110 on the graph 104. Non-limiting aspects are described with respect to FIGS. 3-9.

FIG. 3 illustrates an example, non-limiting block diagram 300 showing the plurality of partitions 202 in accordance with one or more embodiments described herein.

In various embodiments, the training component 118 can electronically decompose, electronically fragment, electronically separate, or otherwise electronically break up the graph 104 into the plurality of partitions 202. In various aspects, the plurality of partitions 202 can have or otherwise include q partitions, for any suitable positive integer q>1: a partition 202(1) to a partition 202(q). In various instances, each of the plurality of partitions 202 can be considered as a subgraph of the graph 104. In other words, each of the plurality of partitions 202 can contain a subset of the plurality of nodes 106 and a subset of the plurality of edges 108. As a non-limiting example, the partition 202(1) can have or otherwise be made up of a set of nodes 202(1)(a) and a set of edges 202(1)(b), where the set of nodes 202(1)(a) can be any suitable subset of the plurality of nodes 106, and where the set of edges 202(1)(b) can be whichever of the plurality of edges 108 that couple together any two of the set of nodes 202(1)(a). As another non-limiting example, the partition 202(q) can have or otherwise be made up of a set of nodes 202(q)(a) and a set of edges 202(q)(b), where the set of nodes 202(q)(a) can be any suitable subset of the plurality of nodes 106, and where the set of edges 202(q)(b) can be whichever of the plurality of edges 108 that couple together any two of the set of nodes 202(q)(a). In various instances, any two of the plurality of partitions 202 can have the same or different sizes as each other. That is, any two of the plurality of partitions 202 can have the same or different numbers of nodes or the same or different numbers of edges as each other. In various cases, all of the plurality of partitions 202 can be disjoint or otherwise non-overlapping with each other. In other words, it can be the case that each of the plurality of nodes 106 belongs to exactly one of the plurality of partitions 202 (e.g., none of the plurality of partitions 202 can share nodes). However, in other cases, any of the plurality of partitions 202 can be non-disjoint or otherwise overlapping with each other. That is, it can be the case that at least one of the plurality of nodes 106 belongs to more than one of the plurality of partitions 202 (e.g., some of the plurality of partitions 202 can share nodes). In any case, the plurality of partitions 202 can be considered as fitting together like the pieces of a puzzle so as to form the graph 104. That is, the union of the plurality of partitions 202 (plus any inter-partition edges) can be equivalent to the graph 104.

Although the herein disclosure mainly describes embodiments in which the training component 118 decomposes or fragments the graph 104 into the plurality of partitions 202, these are mere non-limiting examples for case of explanation and illustration. In other embodiments, any other suitable computing device (not shown) can have already decomposed or fragmented the graph 104 into the plurality of partitions 202, and the access component 116 can electronically receive, retrieve, obtain, or otherwise access the plurality of partitions 202. In any case, the training component 118 can be considered as being able to electronically interact with the plurality of partitions 202.

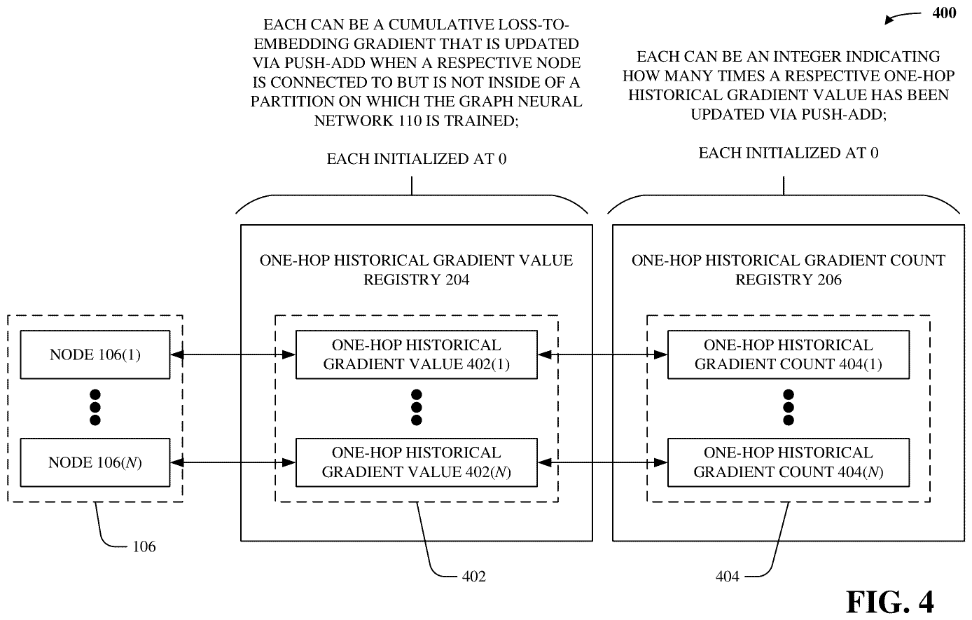

FIG. 4 illustrates an example, non-limiting block diagram 400 of the one-hop historical gradient value registry 204 and the one-hop historical gradient count registry 206 in accordance with one or more embodiments described herein.

In various aspects, the one-hop historical gradient value registry 204 can have, include, or otherwise be made up of a plurality of one-hop historical gradient values 402. In various instances, the plurality of one-hop historical gradient values 402 can respectively correspond (e.g., in one-to-one fashion) to the plurality of nodes 106. Accordingly, since the plurality of nodes 106 can include n nodes, the plurality of one-hop historical gradient values 402 can likewise include n values: a one-hop historical gradient value 402(1) to a one-hop historical gradient value 402(n). In various cases, each of the plurality of one-hop historical gradient values 402 can be a cumulative loss-to-embedding gradient of a respective one of the plurality of nodes 106. Moreover, each of the plurality of one-hop historical gradient values 402 can be updated via a push-add operation whenever a respective one of the plurality of nodes 106 qualifies as a one-hop node. Furthermore, each of the plurality of on-hop historical gradient values 402 can be initialized at 0.

As a non-limiting example, the one-hop historical gradient value 402(1) can correspond to the node 106(1). As described later herein, the training component 118 can train the GNN 110 on each of the plurality of partitions 202. The node 106(1) can qualify or otherwise be considered as a one-hop node when the following two conditions are satisfied: the GNN 110 is currently or presently being trained on a partition that does not contain the node 106(1); and the node 106(1) shares an edge with at least one node that is contained in the partition on which the GNN 110 is currently or presently being trained. So, the one-hop historical gradient value 402(1) can be a scalar whose magnitude is initially set at 0. Each time that the training component 118 determines or concludes that the node 106(1) qualifies as a one-hop node, the training component 118 can update the one-hop historical gradient value 402(1) as follows. The training component 118 can compute or calculate a gradient or partial derivative of: a training loss exhibited by the GNN 110 for whichever of the plurality of partitions 202 that the GNN 110 is currently or presently being trained on; with respect to a most-recent or otherwise previous (hence the term “historical”) embedding that the GNN 110 has produced for the node 106(1). The training component 118 can then push-add that computed or calculated gradient to the one-hop historical gradient value 402(1). In other words, the new magnitude of the one-hop historical gradient value 402(1) can be equal to: its current magnitude; plus that computed or calculated gradient.

As another non-limiting example, the one-hop historical gradient value 402(n) can correspond to the node 106(n). Again, as will be described later herein, the training component 118 can train the GNN 110 on each of the plurality of partitions 202. The node 106(n) can qualify or otherwise be considered as a one-hop node when the following two conditions are satisfied: the GNN 110 is currently or presently being trained on a partition that does not contain the node 106(n); and the node 106(n) shares an edge with at least one node that is contained in the partition on which the GNN 110 is currently or presently being trained. Thus, the one-hop historical gradient value 402(n) can be a scalar whose magnitude is initially set at 0. Each time that the training component 118 determines or concludes that the node 106(n) qualifies as a one-hop node, the training component 118 can update the one-hop historical gradient value 402(n) as follows. The training component 118 can compute or calculate a gradient or partial derivative of: a training loss exhibited by the GNN 110 for whichever of the plurality of partitions 202 that the GNN 110 is currently or presently being trained on; with respect to a most-recent or otherwise previous (hence the term “historical”) embedding of the node 106(n). The training component 118 can then push-add that computed or calculated gradient to the one-hop historical gradient value 402(n). In other words, the new magnitude of the one-hop historical gradient value 402(n) can be equal to: its current magnitude; plus that computed or calculated gradient.

In various aspects, the one-hop historical gradient count registry 206 can have, include, or otherwise be made up of a plurality of one-hop historical gradient counts 404. In various instances, the plurality of one-hop historical gradient counts 404 can respectively correspond (e.g., in one-to-one fashion) to the plurality of nodes 106 and to the plurality of one-hop historical gradient values 402. Accordingly, since the plurality of nodes 106 can include n nodes, and since the plurality of one-hop historical gradient values 402 can include n values, the plurality of one-hop historical gradient counts 404 can likewise include n counts: a one-hop historical gradient count 404(1) to a one-hop historical gradient count 404(n). In various cases, each of the plurality of one-hop historical gradient counts 404 can be an integer that indicates how many times a respective one of the plurality of one-hop historical gradient values 402 has been updated via a push-add operation. Moreover, each of the plurality of one-hop historical gradient counts 404 can be initialized at 0.

As a non-limiting example, the one-hop historical gradient count 404(1) can correspond to the node 106(1) and to the one-hop historical gradient value 402(1). Accordingly, the one-hop historical gradient count 404(1) can be a scalar that is initially 0, and the training component 118 can increment the one-hop historical gradient count 404(1) by 1 (e.g., can add 1 to the one-hop historical gradient count 404(1)) each time that the training component 118 updates the one-hop historical gradient value 402(1).

As another non-limiting example, the one-hop historical gradient count 404(n) can correspond to the node 106(n) and to the one-hop historical gradient value 402(n). Accordingly, the one-hop historical gradient count 404(n) can be a scalar that is initially 0, and the training component 118 can increment the one-hop historical gradient count 404(n) by 1 (e.g., can add 1 to the one-hop historical gradient count 404(n)) each time that the training component 118 updates the one-hop historical gradient value 402(n).

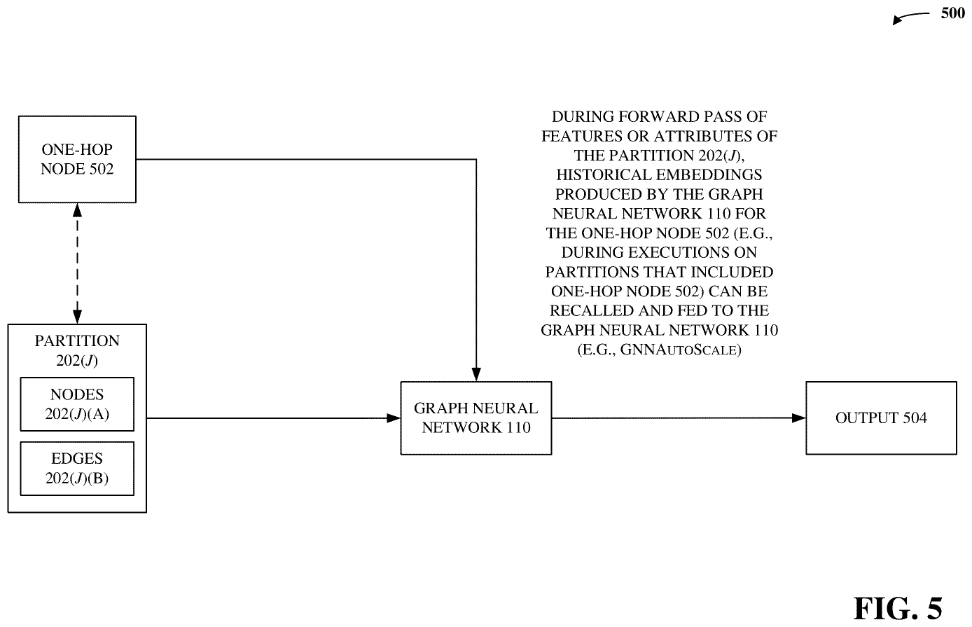

In various embodiments, the training component 118 can train (e.g., starting from randomly-initialized parameters, or from non-randomly-initialized parameters) the GNN 110 on each of the plurality of partitions 202, and such training can utilize or otherwise leverage the one-hop historical gradient value registry 204 and the one-hop historical gradient count registry 206. Non-limiting aspects are described with respect to FIGS. 5-9.

FIGS. 5-9 illustrate example, non-limiting block diagrams 500, 600, 700, 800, and 900 showing how the GNN 110 can be trained on any one of the plurality of partitions 202 in accordance with one or more embodiments described herein.

For consider FIG. 5. There can be a partition 202(j), for any suitable positive integer 1≤j≤q. The partition 202(j) can thus be considered as being made up of a set of nodes 202(j)(a) and a set of edges 202(j)(b). In various instances, the training component 118 can execute the GNN 110 on the partition 202(j). In various cases, such execution can cause the GNN 110 to produce an output 504. More specifically, the training component 118 can feed or route to the input layer of the GNN 110 whatever attributes, features, or properties are associated with the set of nodes 202(j)(a) and with the set of edges 202(j)(b). In various aspects, such attributes, features, or properties can complete a forward pass through the one or more hidden layers of the GNN 110. In various instances, the output layer of the GNN 110 can compute or otherwise calculate the output 504 based on whatever activation maps are provided by the one or more hidden layers of the GNN 110.

Now, suppose that the partition 202(j) has a one-hop node 502. In other words, the one-hop node 502 can be any of the set of nodes 106 that is not contained within the set of nodes 202(j)(a) but that shares an edge with at least one of the set of nodes 202(j)(a). Although FIG. 5 shows the partition 202(j) as having a single one-hop node, this is a mere non-limiting example for case of explanation and illustration. It should be appreciated or otherwise understood that the partition 202(j) can, in some instances, have two or more one-hop nodes. In any case, any of the hidden layers of the GNN 110 can be message passing layers or graph convolutional layers that update the embeddings of any given nodes based on previously-produced embeddings of not just those given nodes but also of whichever nodes neighbor (e.g., share an edge with) those given nodes. Since the one-hop node 502 shares an edge with at least one of the set of nodes 202(j)(a), at least some of the message passing layers or graph convolutional layers of the GNN 110 can, during the forward pass of the attributes, features, or properties of the partition 202(j), be configured to receive previously-produced embeddings of the one-hop node 502. Thus, during such forward pass, the training component 118 can recall or otherwise retrieve any suitable historical embeddings that the GNN 110 has previously produced for the one-hop node 502 (e.g., that hidden layers of the GNN 110 produced during a previous execution on a partition that contained the one-hop node 502) and can feed or route such historical embeddings to the appropriate message passing layers or graph convolutional layers in the GNN 110. Thus, those historical embeddings of the one-hop node 502 can be considered as accompanying the attributes, features, or properties of the partition 202(j) during the forward pass. Accordingly, the output 504 can be based not just on the attributes, features, or properties of the partition 202(j), but also on the historical embeddings of the one-hop node 502. It should be understood or otherwise appreciated that such utilization of historical embeddings of the one-hop node 502 can be considered as an application of the GAS technique.

In any case, note that the format, size, or dimensionality of the output 504 can be dictated by the number, arrangement, sizes, or other characteristics of the neurons, convolutional kernels, LSTM layers, or other internal parameters of the output layer (or of any other layers) of the GNN 110. Accordingly, the output 504 can be forced to have any desired format, size, or dimensionality, by adding, removing, or otherwise adjusting characteristics of the output layer (or of any other layers) of the GNN 110. In various aspects, the output 504 can be considered as the predicted or inferred inferencing task result that the GNN 110 believes should correspond to the partition 202(j). As a non-limiting example, suppose that the inferencing task is node-wise classification. In such case, the output 504 can contain, include, or otherwise be a respective classification label for each of the set of nodes 202(j)(a). As another non-limiting example, suppose that the inferencing task is edge-wise classification. In such case, the output 504 can contain, include, or otherwise be a respective classification label for each of the set of edges 202(j)(b). As still another non-limiting example, suppose that the inferencing task is graph-level classification. In such case, the output 504 can contain, include, or otherwise be a classification label for the entirety of the partition 202(j). Regardless of the specific format or content of the output 504, note that, if the GNN 110 has so far undergone no or little training, then the output 504 can be highly inaccurate or incorrect.

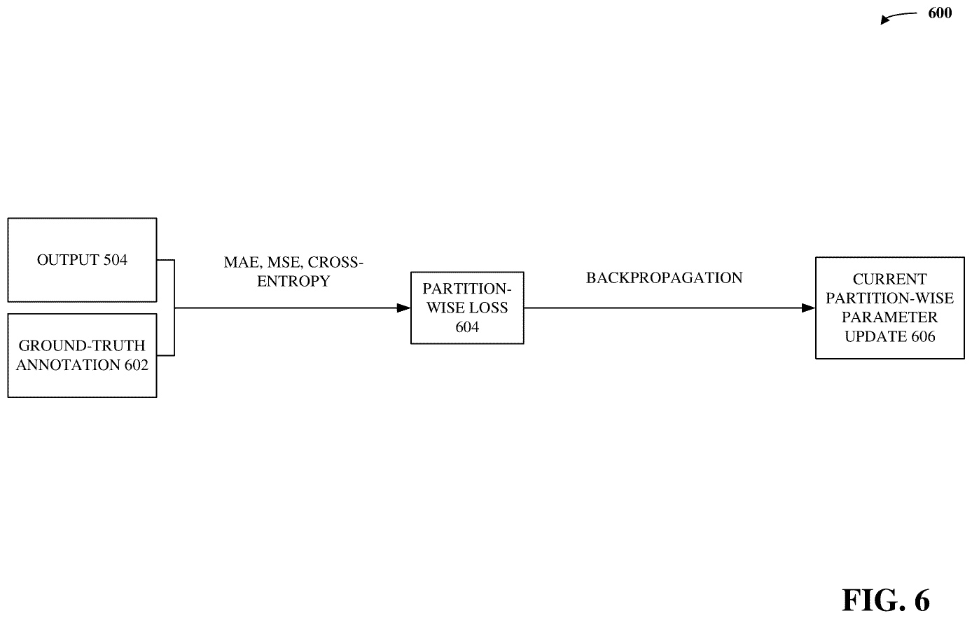

Next, consider FIG. 6. In various aspects, there can be a ground-truth annotation 602. In various instances, the ground-truth annotation 602 can be whatever correct or accurate inferencing task result is known or deemed to correspond to the partition 202(j). As a non-limiting example, if the inferencing task is node-wise classification, the ground-truth annotation 602 can contain, include, or otherwise be a respective correct or accurate classification label that is known or deemed to correspond to each of the set of nodes 202(j)(a). As another non-limiting example, if the inferencing task is edge-wise classification, the ground-truth annotation 602 can contain, include, or otherwise be a respective correct or accurate classification label that is known or deemed to correspond to each of the set of edges 202(j)(b). As even another non-limiting example, if the inferencing task is graph-level classification, the ground-truth annotation 602 can contain, include, or otherwise be a correct or accurate classification label that is known or deemed to correspond to the entirety of the partition 202(j).

In various cases, the training component 118 can compute a partition-wise loss 604, based on the output 504 and on the ground-truth annotation 602. More specifically, the partition-wise loss 604 can be equal to or otherwise based on any suitable error (e.g., MAE, MSE, cross-entropy error) between the output 504 and the ground-truth annotation 602. In various aspects, the training component 118 can apply any suitable backpropagation technique (e.g., stochastic gradient descent) to the partition-wise loss 604. In various cases, the numerical or mathematical results of such backpropagation can be referred to as a current partition-wise parameter update 606. In other words, the current partition-wise parameter update 606 can be any suitable electronic data specifying by how much each learnable or trainable parameter of the GNN 110 should be respectively increased or decreased so as to reduce or minimize the partition-wise loss 604. Note that the term “current” can be considered as appropriate, since the partition-wise loss 604 is based on the partition 202(j), which is the partition that the GNN 110 is currently or presently being trained on.

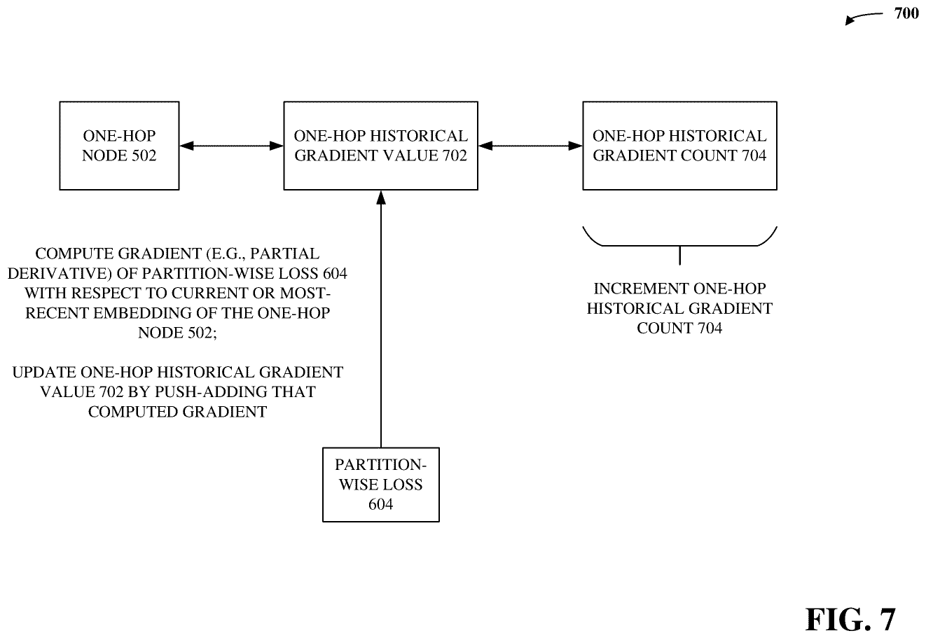

Now, consider FIG. 7. In various embodiments, there can be a one-hop historical gradient value 702 and a one-hop historical gradient count 704. In various aspects, the one-hop historical gradient value 702 can be whichever of the plurality of one-hop historical gradient values 402 that corresponds to the one-hop node 502. Likewise, the one-hop historical gradient count 704 can be whichever of the plurality of one-hop historical gradient counts 404 that corresponds to the one-hop node 502. In various instances, the training component 118 can update the one-hop historical gradient value 702 based on the partition-wise loss 604. More specifically, the training component 118 can compute or calculate a gradient (otherwise referred to as a partial derivative) of: the partition-wise loss 604; with respect to whatever current or most-recent historical embedding corresponds to the one-hop node 502. In various cases, the training component 118 can push-add that computed gradient to the one-hop historical gradient value 702. In other words, the new state of the one-hop historical gradient value can be equal to the sum of: the current state of the one-hop historical gradient value 702; and the gradient of the partition-wise loss 604 with respect to the current or most-recent historical embedding of the one-hop node 502. In various aspects, the training component 118 can, in response to updating the one-hop historical gradient value 702, also update the one-hop historical gradient count 704. In particular, the training component 118 can increment the one-hop historical gradient count 704 by 1.

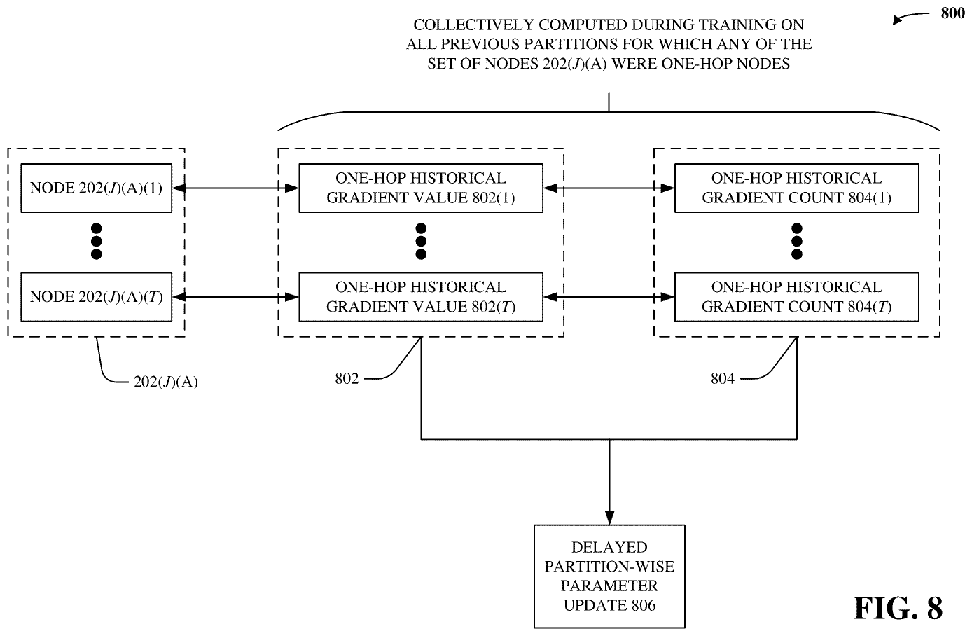

Consider FIG. 8. In various embodiments, there can be a set of one-hop historical gradient values 802 and a set of one-hop historical gradient counts 804. In various aspects, the set of one-hop historical gradient values 802 and the set of one-hop historical gradient counts 804 can respectively correspond to the set of nodes 202(j)(a). For example, suppose that the set of nodes 202(j)(a) has t nodes, for any suitable positive integer t: a node 202(j)(a)(1) to a node 202(j)(a)(1). In such case, the set of one-hop historical gradient values 802 can thus have t values: a one-hop historical gradient value 802(1) to a one-hop historical gradient value 802(1). Likewise, the set of one-hop historical gradient counts 804 can have t counts: a one-hop historical gradient count 804(1) to a one-hop historical gradient count 804(1). In various aspects, each of the set of one-hop historical gradient values 802 can be whichever of the plurality of one-hop historical gradient values 402 that corresponds to a respective one of the set of nodes 202(j)(a) (e.g., the one-hop historical gradient value 802(1) can be whichever of the plurality of one-hop historical gradient values 402 that corresponds to the node 202(j)(a)(1); the one-hop historical gradient value 802(1) can be whichever of the plurality of one-hop historical gradient values 402 that corresponds to the node 202(j)(a)(1)). Similarly, each of the set of one-hop historical gradient counts 804 can be whichever of the plurality of one-hop historical gradient counts 404 that corresponds to a respective one of the set of nodes 202(j)(a) (e.g., the one-hop historical gradient count 804(1) can be whichever of the plurality of one-hop historical gradient counts 404 that corresponds to the node 202(j)(a)(1); the one-hop historical gradient count 804(1) can be whichever of the plurality of one-hop historical gradient counts 404 that corresponds to the node 202(j)(a)(1)).

In various instances, the training component 118 can compute or otherwise calculate a delayed partition-wise parameter update 806, based on the set of one-hop historical gradient values 802 and the set of one-hop historical gradient counts 804. As a non-limiting example, the delayed partition-wise parameter update 806 can be equal to or otherwise based on any suitable weighted or unweighted dot product between the set of one-hop historical gradient values 802 and the set of one-hop historical gradient counts 804. In particular, the training component 118 can multiply the one-hop historical gradient value 802(1) by the reciprocal of the one-hop historical gradient count 804(1) and by a derivative of a current or most-recent historical embedding of the node 202(j)(a)(1) with respect to the learnable or trainable parameters of the GNN 110, thereby yielding a first multiplicative product. In like fashion, the training component 118 can multiply the one-hop historical gradient value 802(1) by the reciprocal of the one-hop historical gradient count 804(1) and by a derivative of a current or most-recent historical embedding of the node 202(j)(a)(1) with respect to the learnable or trainable parameters of the GNN 110, thereby yielding a 1-th multiplicative product. In various instances, the training component 118 can sum, average, or otherwise aggregate those t multiplicative products together in weighted fashion or in unweighted fashion, and the result of such summing, averaging, or aggregation can be considered as the delayed partition-wise parameter update 806. It should be understood that any node of the partition 202(j) whose one-hop historical gradient count is 0 when the delayed partition-wise parameter update 806 is being computed can be omitted or left out of such computation.

Note that the set of one-hop historical gradient values 802 and the set of one-hop historical gradient counts 804 can all have been initialized at 0 and can have been previously updated by the training component 118 during previous executions of the GNN 110 on others of the plurality of partitions 202 (e.g., on partitions that are not the partition 202(j)). Accordingly, the term “delayed” can be considered as appropriate (e.g., the set of one-hop historical gradient values 802 and the set of one-hop historical gradient counts 804 capture information regarding how the GNN 110 performed during previous executions on previous partitions).

In various cases, the training component 118 can, in response to computation of the delayed partition-wise parameter update 806, reset to zeros all of the set of one-hop historical gradient values 802 and all of the set of one-hop historical gradient counts 804.

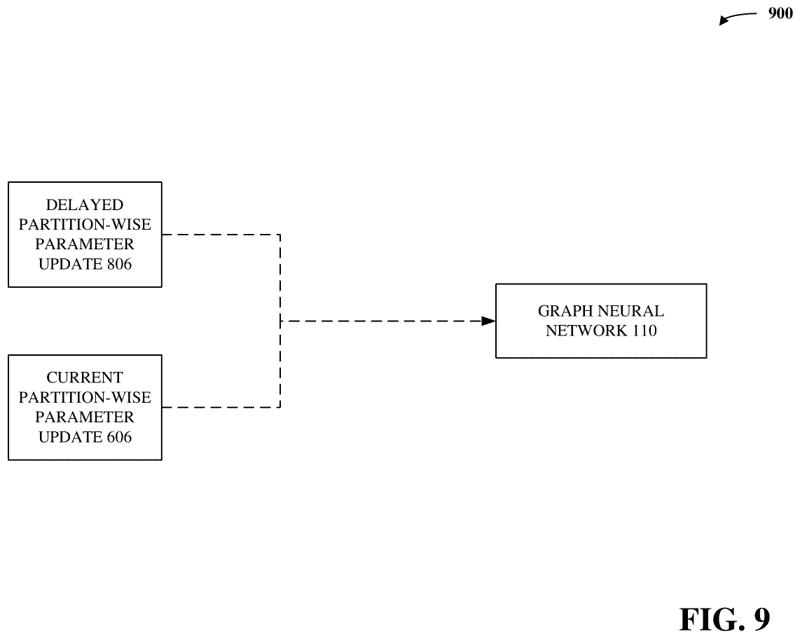

Now, consider FIG. 9. In various embodiments, the training component 118 can electronically apply both the current partition-wise parameter update 606 and the delayed partition-wise parameter update 806 to the GNN 110. In other words, the training component 118 can incrementally change the learnable or trainable parameters of the GNN 110 in whatever ways are specified by the current partition-wise parameter update 606 and by the delayed partition-wisc parameter update 806. Note that the current partition-wise parameter update 606 can be considered as specifying how to change the learnable or trainable parameters of the GNN 110 based on the set of nodes 202(j)(a) serving as members of the partition 202(j). In contrast, the delayed partition-wise parameter update 806 can be considered as specifying how to change the learnable or trainable parameters of the GNN 110 based on the set of nodes 202(j)(a) having previously served as one-hop nodes of other partitions.

In various aspects, the training component 118 can train the GNN 110 in this fashion (e.g., as described with respect to FIGS. 5-9) one or more times on each of the plurality of partitions 202. This can ultimately cause the learnable or trainable parameters of the GNN 110 to become iteratively optimized for accurately, correctly, or reliably performing the inferencing task on any suitable inputted graphs or partitions thereof. It should be understood or otherwise appreciated that the training component 118 can implement any suitable number of training epochs or any suitable training termination criterion.

Although FIGS. 5-9 mainly concern supervised training of the GNN 110, this is a mere non-limiting example for ease of explanation and illustration. It should be appreciated that the training component 118 can leverage any other suitable type or paradigm of training (e.g., unsupervised training, semi-supervised training, reinforcement learning, federated training) with respect to the GNN 110.

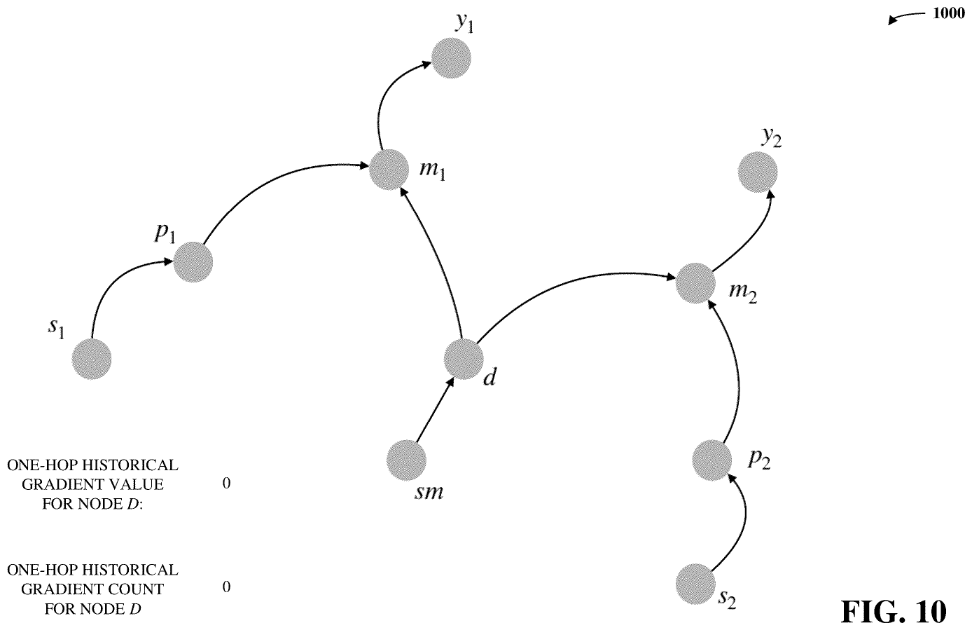

FIGS. 10-13 illustrate example, non-limiting block diagrams showing how a one-hop historical gradient value and a one-hop historical gradient count of a particular node can change during training in accordance with one or more embodiments described herein.

First, consider FIG. 10. In various embodiments, there can be a graph 1000. In the non-limiting example of FIG. 10, nodes p₁ and p₂ can represent proteins; nodes s₁ and S₂ can represent amino acid sequences of those two proteins; nodes m₁ and m₂ can represent experiments conducted on those two proteins; nodes y₁ and y₂ can represent numerical measures acquired from those experiments (e.g., binding affinity measurements); node d can represent a developmental medication; and node sm can represent the simplified molecular input line entry system (SMILES) notation of that developmental medication. In the non-limiting example of FIG. 10, the graph 1000 has directional edges.

For explanatory purposes of this non-limiting example, the following discussion will consider how the one-hop historical gradient value of the node d and the one-hop historical gradient count of the node d change during training of the GNN 110 on the graph 1000. Initially, the one-hop historical gradient value for the node d can be 0, and the one-hop historical gradient count for the node d can also be 0.

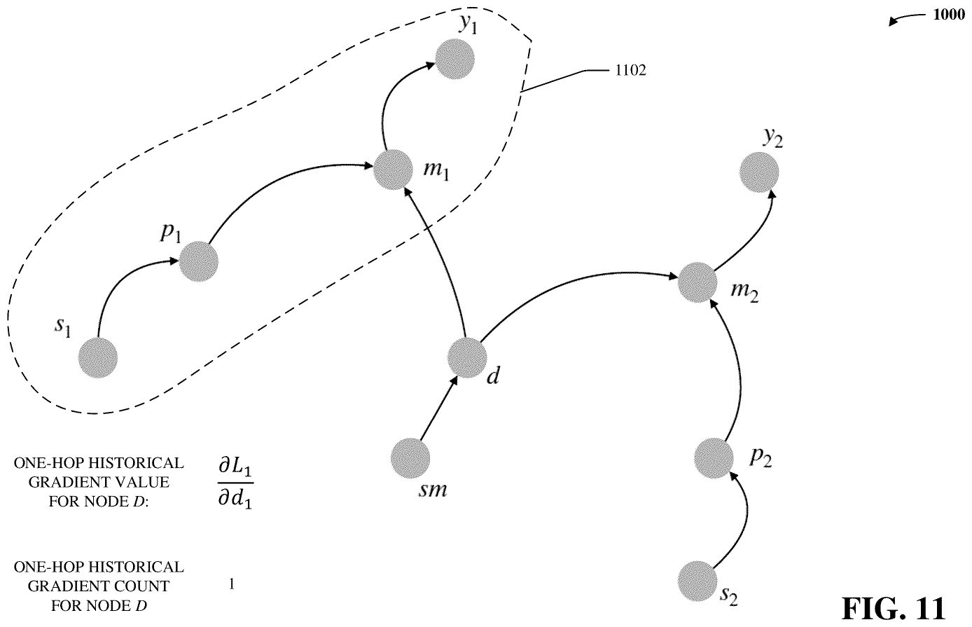

Now, consider FIG. 11. Suppose that the GNN 110 is trained on a partition 1102 of the graph 1000. That is, the GNN 110 can be executed on the partition 1102, and a loss LA can be computed based on the performance of the GNN 110 with respect to the partition 1102. For example, the loss L can be equal to an error between: the inferencing task result that the GNN 110 creates for the partition 1102; and a ground-truth annotation that is known to correspond to the partition 1102. Accordingly, the learnable or trainable parameters of the GNN 110 can be updated in a normal or standard fashion by applying backpropagation to the loss L₁. Now, note that the node d qualifies as a one-hop node of the partition 1102. After all, the node d is not in the partition 1102 but does share an edge with at least one node (e.g., m₁) that is in the partition 1102. Because the node d is a one-hop node of the partition 1102, one or more historical embeddings of the node d can be recalled and fed into appropriate hidden layers of the GNN 110 while the partition 1102 is completing its forward pass through the GNN 110. Additionally, because the node d is a one-hop node of the partition 1102, the one-hop historical gradient value for the node d can be updated. Specifically, the one-hop historical gradient value for the node d can be updated by push-adding to its current value (0) the following quantity:

$$\frac{\partial {L}_{1}}{\partial {d}_{1}}$$

where d₁ can represent any historical embedding of the node d at whatever time that the loss L₁ is computed. In some instances, d₁ can represent a current, present-time, or most-recent historical embedding of the node d. In any case, in response to the one-hop historical gradient value for the node d being updated, the one-hop historical gradient count for the node d can be incremented from 0 to 1.

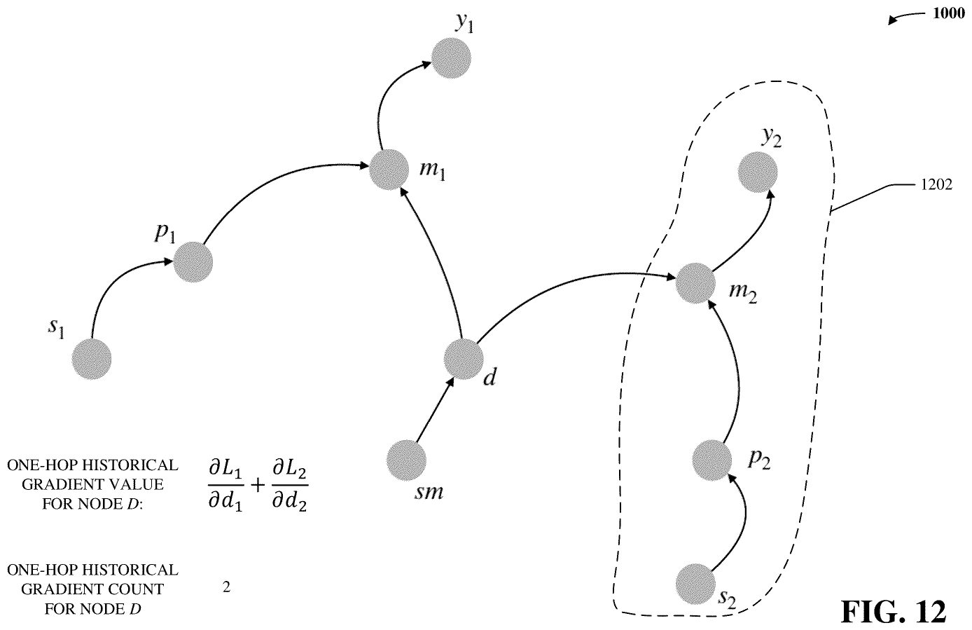

Next, consider FIG. 12. Suppose that the GNN 110 is subsequently trained on a partition 1202 of the graph 1000. That is, the GNN 110 can be executed on the partition 1202, and a loss L₂ can be computed based on the performance of the GNN 110 with respect to the partition 1202. For example, the loss L₂ can be equal to an error between: the inferencing task result that the GNN 110 creates for the partition 1202; and a ground-truth annotation that is known to correspond to the partition 1202. Accordingly, the learnable or trainable parameters of the GNN 110 can be updated in a normal or standard fashion by applying backpropagation to the loss L₂. Note that the node d qualifies as a one-hop node of the partition 1202. After all, the node d is not in the partition 1202 but does share an edge with at least one node (e.g., m₂) that is in the partition 1202. Because the node d is a one-hop node of the partition 1202, one or more historical embeddings of the node d can be recalled and fed into appropriate hidden layers of the GNN 110 while the partition 1202 is completing its forward pass through the GNN 110. Additionally, because the node d is a one-hop node of the partition 1202, the one-hop historical gradient value for the node d can be updated. Specifically, the one-hop historical gradient value for the node d can be updated by push-adding to its current value

$$( \frac{\partial {L}_{1}}{\partial {d}_{1}} )$$

the following quantity:

$$\frac{\partial {L}_{2}}{\partial {d}_{2}}$$

where d₂ can represent any historical embedding of the node d at whatever time that the loss L₂ is computed. In some instances, d₂ can represent a now-current, now-present-time, or now-most-recent historical embedding of the node d. Note that d₁ and d₂ can be the same or different as each other. In any case, the one-hop historical gradient value for the node d can now be

$$\frac{\partial {L}_{1}}{\partial {d}_{1}} + \frac{\partial {L}_{2}}{\partial {d}_{2}} .$$

In response to the one-nop historical gradient value for the node d being updated, the one-hop historical gradient count for the node d can be incremented from 1 to 2.

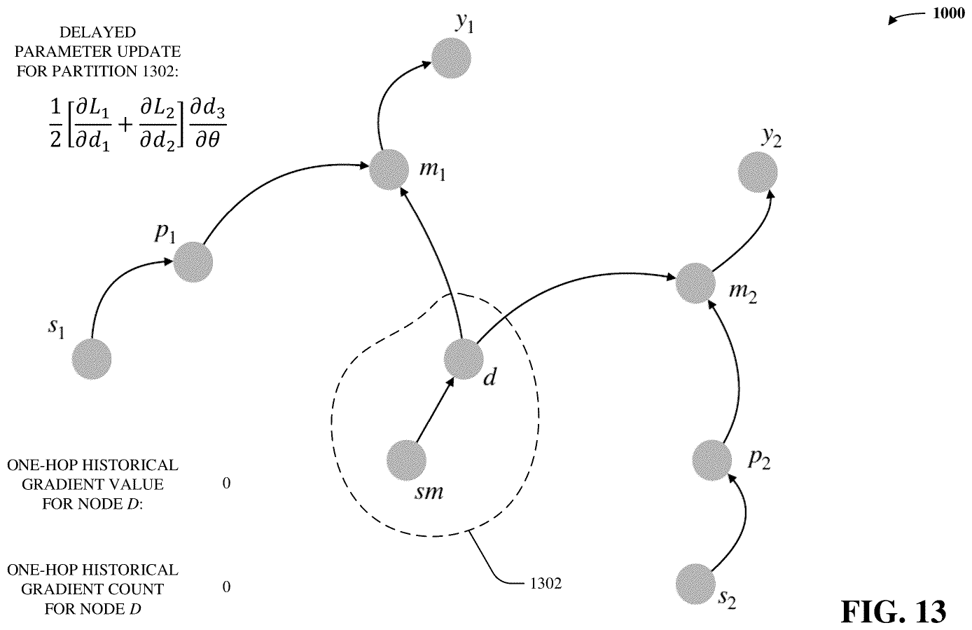

Now, consider FIG. 13. Suppose that the GNN 110 is subsequently trained on a partition 1302 of the graph 1000. That is, the GNN 110 can be executed on the partition 1302, and a loss L₃ can be computed based on the performance of the GNN 110 with respect to the partition 1302. For example, the loss L₃ can be equal to an error between: the inferencing task result that the GNN 110 creates for the partition 1302; and a ground-truth annotation that is known to correspond to the partition 1302. Accordingly, the learnable or trainable parameters of the GNN 110 can be updated in a normal or standard fashion by applying backpropagation to the loss L₃. Note that the node d is contained within the partition 1302. Because the node d is contained within the partition 1302 and has a non-zero one-hop historical gradient count, a delayed parameter update (which is different from or otherwise not accounted for by merely backpropagating from the loss L₃) can be computed based on the node d. In particular, that delayed parameter update can be equal to or otherwise based on the multiplicative product between: the one-hop historical gradient value of the node d; the reciprocal of the one-hop historical gradient count of the node d; and a derivative of a now-current or now-present-time embedding of the node d with respect to the learnable or trainable parameters of the GNN 110. That is, the delayed parameter update can be given by:

$$\frac{1}{2} [ \frac{\partial {L}_{1}}{\partial {d}_{1}} + \frac{\partial {L}_{2}}{\partial {d}_{2}} ] \frac{\partial {d}_{3}}{\partial θ}$$

where d₃ can represent any historical embedding of the node d at whatever time that the loss L₃ is computed, and where θ can represent the learnable or trainable parameters of the GNN 110. Such delayed parameter update can be applied to the GNN 110, in addition to the normal or standard parameter update achieved by performing backpropagation on the loss L₃. It should be understood or otherwise appreciated that such delayed parameter update can be weighted by any suitable learning rate if desired.

In some cases, the efficacy of the delayed parameter update can be increased if the GNN 110 satisfies Lipschitz continuity. It should be understood or otherwise appreciated that the GNN 110 can be forced to satisfy Lipschitz continuity via the inclusion of an auxiliary Lipschitz continuity loss in the training of the GNN 110.

Note that the one-hop historical gradient value of the node d can be considered as representing the cumulative role that the node d has played due to being a one-hop node for partitions that are different from the current or present-time partition (e.g., partition 1302). Furthermore, note that the one-hop historical gradient count of the node d can be considered as a normalization factor that penalizes long delays in gradient updates (e.g., the more times that the node d serves as a one-hop node before being within the current or present-time partition, the more its one-hop historical gradient value is decayed by the reciprocal of its one-hop historical gradient count).

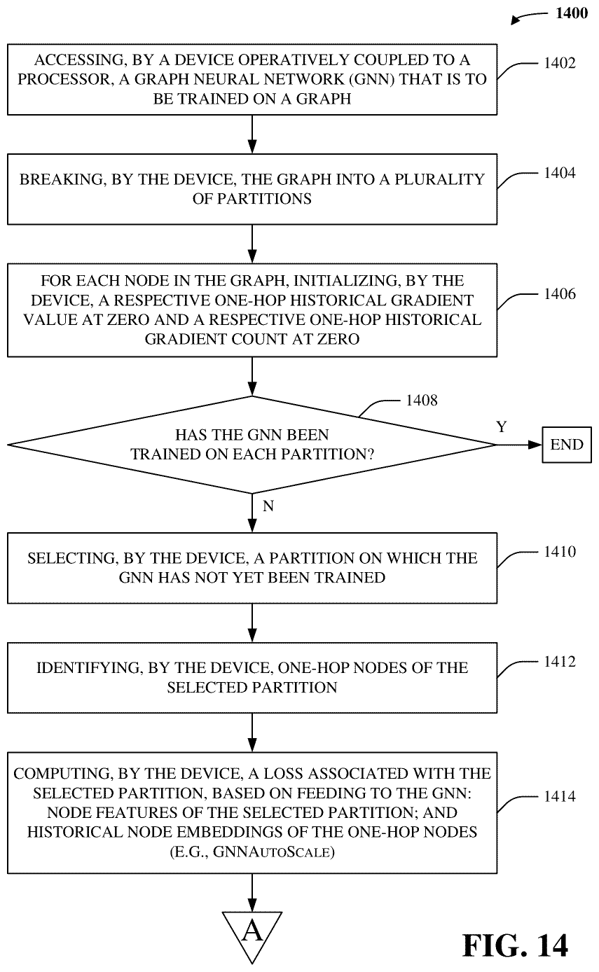

FIGS. 14-17 illustrate flow diagram of example, non-limiting computer-implemented methods 1400, 1500, 1600, and 1700 that can facilitate partitioned training via one-hop historical gradients in accordance with one or more embodiments described herein. In various cases, the one-hop gradient system 102 can facilitate any of the computer-implemented methods 1400, 1500, 1600, or 1700.

First, consider FIG. 14. In various embodiments, act 1402 can include accessing, by a device (e.g., via 116) operatively coupled to a processor (e.g., 112), a GNN (e.g., 110) that is to be trained on a graph (e.g., 104).

In various aspects, act 1404 can include breaking, by the device (e.g., via 118), the graph into a plurality of partitions (e.g., 202).

In various instances, act 1406 can include, for each node in the graph, initializing, by the device (e.g., via 118), a respective one-hop historical gradient value (e.g., respective one of 402) at zero and a respective one-hop historical gradient count (e.g., respective one of 404) at zero.

In various cases, act 1408 can include determining, by the device (e.g., via 118), whether the GNN has been trained on each of the plurality of partitions. If so, the computer-implemented method 1400 can end (e.g., training of the GNN can be considered as complete or terminated). If not, the computer-implemented method 1400 can proceed to act 1410.

In various aspects, act 1410 can include selecting, by the device (e.g., via 118), a partition (e.g., 202(j)) on which the GNN has not yet been trained.

In various instances, act 1412 can include identifying, by the device (e.g., via 118), one-hop nodes (e.g., 502) of the selected partition.

In various cases, act 1414 can include computing, by the device (e.g., via 118), a loss (e.g., 604) associated with the selected partition, based on feeding to the GNN: node features of the selected partition; and historical node embeddings of the one-hop nodes. Note that this can be considered as an application of the GAS technique.

In various aspects, the computer-implemented method 1400 can proceed to act 1502 of the computer-implemented method 1500.

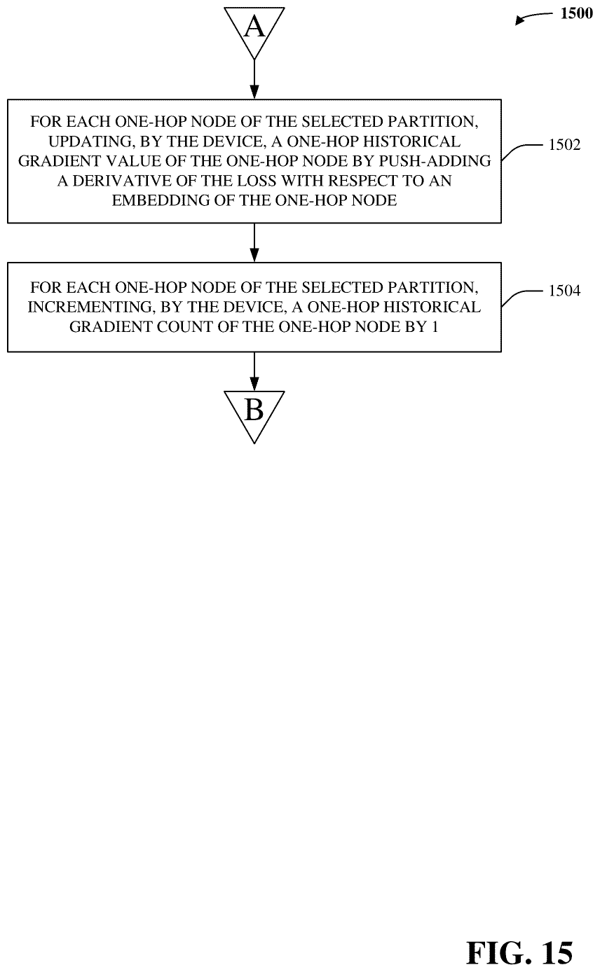

Now, consider FIG. 15. In various instances, act 1502 can include, for each one-hop node of the selected partition, updating, by the device (e.g., via 118), a one-hop historical gradient value (e.g., 702) of the one-hop node by push-adding a derivative of the loss with respect to an embedding of the one-hop node.

In various cases, act 1504 can include, for each one-hop node of the selected partition, incrementing, by the device (e.g., via 118), a one-hop historical gradient count (e.g., 704) of the one-hop node by 1.

In various aspects, the computer-implemented method 1500 can proceed to act 1602 of the computer-implemented method 1600.

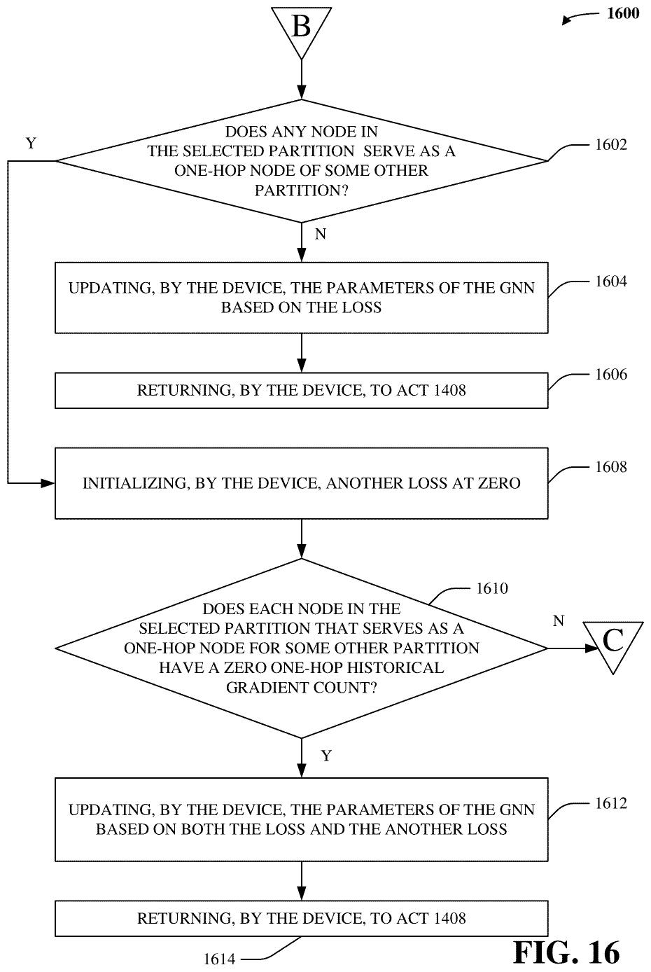

Next, consider FIG. 16. In various instances, act 1602 can include determining, by the device (e.g., via 118), whether any node in the selected partition serves as a one-hop node of some other partition. If not, the computer-implemented method 1600 can proceed to act 1604. If so, the computer-implemented method 1600 can instead proceed to act 1608.

In various cases, act 1604 can include updating, by the device (e.g., via 118), the parameters of the GNN based on the loss (e.g., if no node in the selected partition serves as a one-hop node of some other partition, then there can be no delayed parameter update for the selected partition).

In various aspects, act 1606 can include returning, by the device (e.g., via 118), to act 1408 of the computer-implemented method 1400.

In various instances, act 1608 can include initializing, by the device, another loss (e.g., 806) at zero.

In carious cases, act 1610 can include determining, by the device (e.g., via 118), whether each node in the selected partition that qualifies or serves as a one-hop node from some other partition has a zero one-hop historical gradient count. If so (e.g., if all of the nodes in the selected partition have one-hop historical gradient counts of zero), the computer-implemented method 1600 can proceed to act 1612. If not (e.g., if at least one of the nodes in the selected partition has a non-zero one-hop historical gradient count), the computer-implemented method 1600 can instead proceed to act 1702 of the computer-implemented method 1700.

In various aspects, act 1612 can include updating, by the device (e.g., via 118), the parameters of the GNN based on both the loss and the another loss (e.g., the delayed parameter update can be performed).

In various instances, act 1614 can include returning, by the device (e.g., via 118), to act 1408 of the computer-implemented method 1400.

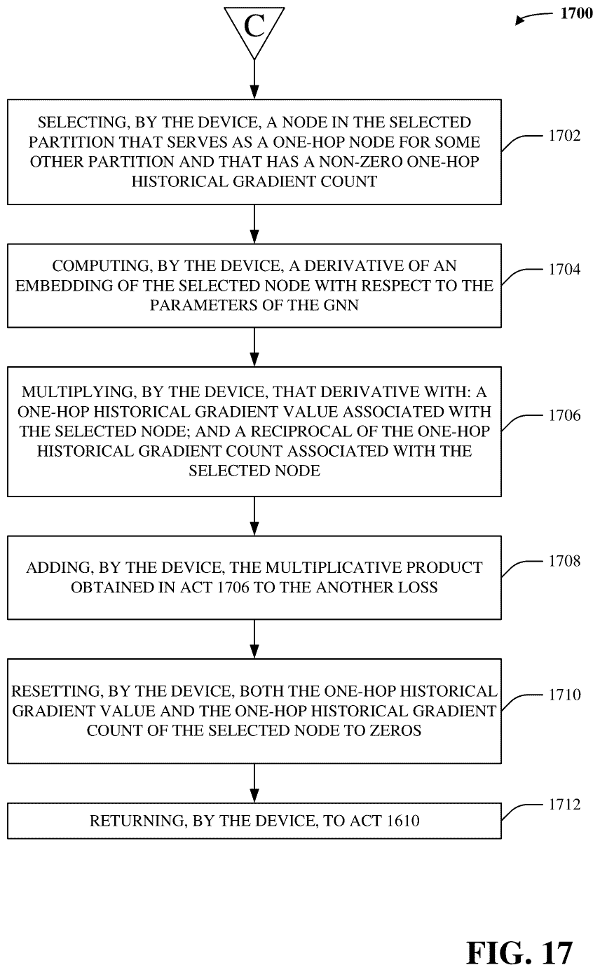

Consider FIG. 17. In various embodiments, act 1702 can include selecting, by the device (e.g., via 118), a node (e.g., 202(j)(a)(1)) in the selected partition that qualifies or serves as a one-hop node for some other partition and that has a non-zero one-hop historical gradient count (e.g., 804(1)).

In various aspects, act 1704 can include computing, by the device (e.g., via 118), a derivative of an embedding of the selected node with respect to the parameters of the GNN. Note that, since the selected node is a member of the selected partition, the content of act 1704 can be rephrased as computation of a gradient of an in-partition node embedding with respect to learnable or trainable parameters of the GNN.

In various instances, act 1706 can include multiplying, by the device (e.g., via 118), that derivative with a one-hop historical gradient value (e.g., 802(1)) associated with the selected node and with a reciprocal of the one-hop historical gradient count associated with the selected node.

In various cases, act 1708 can include adding, by the device (e.g., 118, in weighted or unweighted fashion), the multiplicative product obtained in act 1706 to the another loss.

In various aspects, act 1710 can include resetting, by the device (e.g., via 118), both the one-hop historical gradient value and the one-hop historical gradient count of the selected node to zeros.

In various instances, act 1712 can include returning, by the device (e.g., via 118), to act 1610 of the computer-implemented method 1600.

In various embodiments, the execution component 120 can, in response to termination of training of the GNN 110, deploy the GNN 110 in any suitable operational context so as to perform the inferencing task on inputted graphs for which no ground-truth annotations are available. As a non-limiting example, the execution component 120 can electronically obtain, receive, retrieve, or otherwise access any suitable other graph (not shown), or any suitable partition thereof, and the execution component 120 can electronically execute the GNN 110 on such other graph or on such partition thereof. In various instances, such execution can cause the GNN 110 to produce as inferencing task result for the other graph or for the partition thereof. In various cases, the execution component 120 can electronically render such inferencing task result on any suitable electronic display, or can electronically transmit such inferencing task result to any other suitable computing device.

FIGS. 18-20 illustrate example, non-limiting experimental results in accordance with one or more embodiments described herein. In particular, the present inventors conducted various experiments in which they compared various embodiments described herein (which they sometimes refer to as GradientAutoScale or GRADAS) to existing techniques (to GNNAutoScale or GAS). As shown, FIGS. 18, 19, and 20 respectively depict a chart 1800, a chart 1900, and a chart 2000 that demonstrate training loss versus training epoch achieved by GAS and achieved by GRADAS during partitioned training on three respective graphs. As shown, GRADAS achieved significantly faster minimization of training loss for all three graphs as compared to GAS. In other words, a given or threshold level of GNN inferencing performance can be achieved by GRADAS using far fewer training epochs than would be required by GAS. In other words, GRADAS converges much more quickly than GAS converges. These experimental results verify that various embodiments described herein constitute concrete and tangible technical improvements in the field of GNNs.

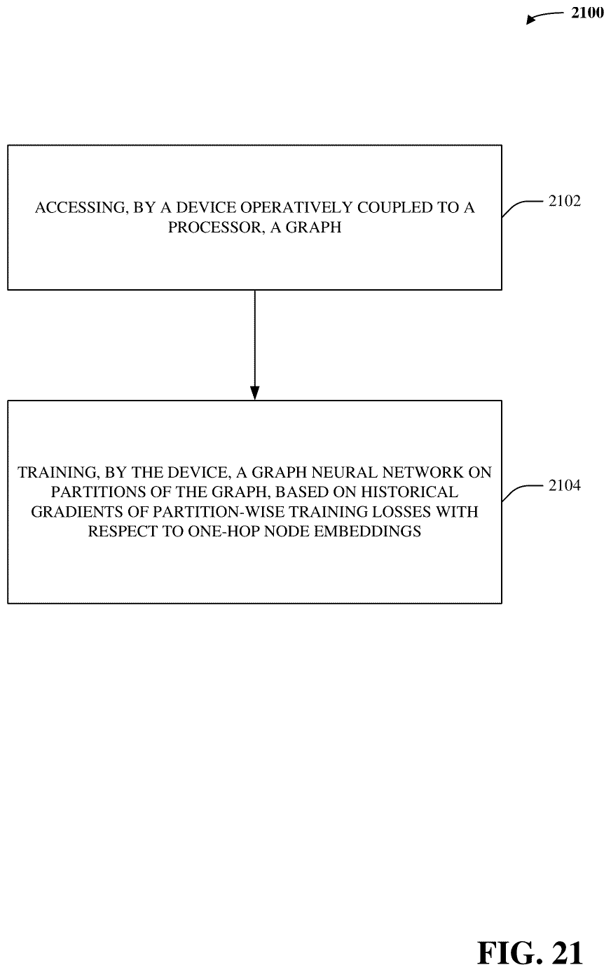

FIG. 21 illustrates a flow diagram of an example, non-limiting computer-implemented method 2100 that can facilitate partitioned training via one-hop historical gradients in accordance with one or more embodiments described herein. In various cases, the one-hop gradient system 102 can facilitate the computer-implemented method 2100.

In various embodiments, act 2102 can include accessing, by a device (e.g., via 116) operatively coupled to a processor (e.g., 112), a graph (e.g., 104).

In various aspects, act 2104 can include training, by the device (e.g., via 118), a graph neural network (e.g., 110) on partitions (e.g., 202) of the graph, based on historical gradients of partition-wise training losses with respect to one-hop node embeddings (e.g., based on 204).

Although not explicitly shown in FIG. 21, a first partition (e.g., 1102) of the graph and a second partition (e.g., 1202) of the graph can have a one-hop node (e.g., d), the one-hop node can correspond to an historical gradient value and to an historical gradient count, the historical gradient value can be initially zero, and the historical gradient count can be initially zero. In various aspects, while training the graph neural network on the first partition, the device: can add to the historical gradient value of the one-hop node a gradient of a first loss of the first partition with respect to a first embedding of the one-hop node

$$( e . g . , \frac{\partial {L}_{1}}{\partial {d}_{1}} ) ;$$

and can increment the historical gradient count. In various instances, while training the graph neural network on the second partition, the device: can add to the historical gradient value a gradient of a second loss of the second partition with respect to a second embedding of the one-hop node

$$( e . g . , \frac{\partial {L}_{2}}{\partial {d}_{2}} ) ;$$

and can increment the historical gradient count. In various cases, while training the graph neural network on a third partition (e.g., 1302) to which the one-hop node belongs, the device: can update the graph neural network based on a third loss (e.g., L₃) of the third partition and based on a product between the historical gradient value and a reciprocal of the historical gradient count

$$( e . g . , \frac{1}{2} [ \frac{\partial {L}_{1}}{\partial {d}_{1}} + \frac{\partial {L}_{2}}{\partial {d}_{2}} ] ) .$$

In various aspects, the device: can reset the historical gradient value to zero and the historical gradient count to zero, in response to updating the graph neural network based on the third loss.

Although not explicitly shown in FIG. 21, the partitions of the graph can be disjoint or can instead be overlapping.

Although not explicitly shown in FIG. 21, the computer-implemented method 2100 can include: executing, by the device (e.g., via 120) and post-training, the graph neural network on another graph, thereby yielding an inferencing task result for the another graph.

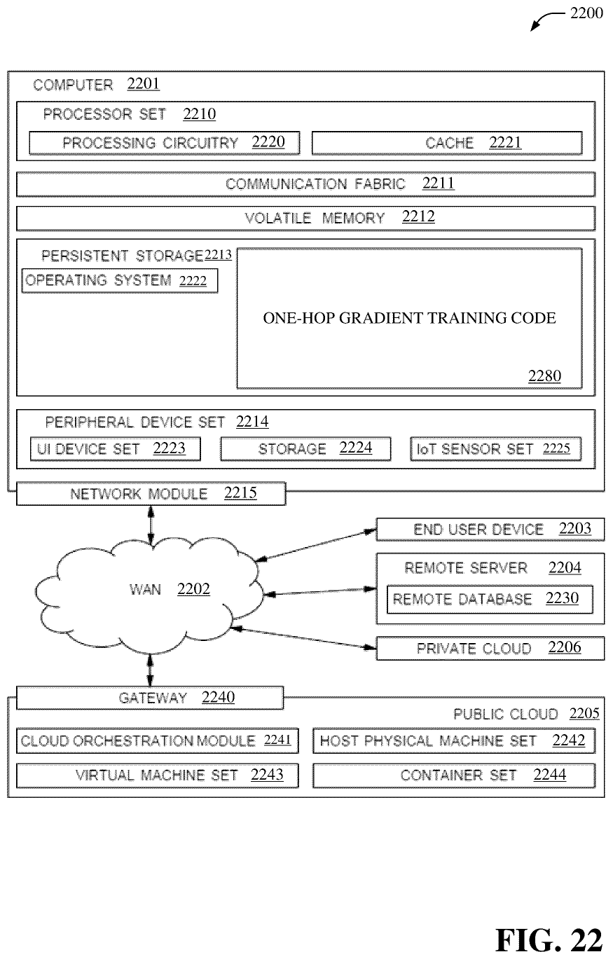

FIG. 22 and the following discussion are intended to provide a brief, general description of a suitable computing environment 2200 in which one or more embodiments described herein can be implemented. For example, various aspects of the present disclosure are described by narrative text, flowcharts, block diagrams of computer systems or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks can be performed in reverse order, as a single integrated step, concurrently or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions or data for performing computer operations specified in a given CPP claim. A “storage device” is any tangible device that can retain and store instructions for use by a computer processor. Without limitation, the computer readable storage medium can be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include diskette, hard disk, random access memory (RAM), read-only memory (ROM), erasable programmable read-only memory (EPROM or Flash memory), static random-access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

Computing environment 2200 contains an example of an environment for the execution of at least some of the computer code involved in performing the inventive methods, such as one-hop gradient training code 2280. In addition to block 2280, computing environment 2200 includes, for example, computer 2201, wide area network (WAN) 2202, end user device (EUD) 2203, remote server 2204, public cloud 2205, and private cloud 2206. In this embodiment, computer 2201 includes processor set 2210 (including processing circuitry 2220 and cache 2221), communication fabric 2211, volatile memory 2212, persistent storage 2213 (including operating system 2222 and block 2280, as identified above), peripheral device set 2214 (including user interface (UI), device set 2223, storage 2224, and Internet of Things (IoT) sensor set 2225), and network module 2215. Remote server 2204 includes remote database 2230. Public cloud 2205 includes gateway 2240, cloud orchestration module 2241, host physical machine set 2242, virtual machine set 2243, and container set 2244.

COMPUTER 2201 can take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 2230. As is well understood in the art of computer technology, and depending upon the technology, performance of a computer-implemented method can be distributed among multiple computers or between multiple locations. On the other hand, in this presentation of computing environment 2200, detailed discussion is focused on a single computer, specifically computer 2201, to keep the presentation as simple as possible. Computer 2201 can be located in a cloud, even though it is not shown in a cloud in FIG. 22. On the other hand, computer 2201 is not required to be in a cloud except to any extent as can be affirmatively indicated.

PROCESSOR SET 2210 includes one, or more, computer processors of any type now known or to be developed in the future. Processing circuitry 2220 can be distributed over multiple packages, for example, multiple, coordinated integrated circuit chips. Processing circuitry 2220 can implement multiple processor threads or multiple processor cores. Cache 2221 is memory that is located in the processor chip package(s) and is typically used for data or code that should be available for rapid access by the threads or cores running on processor set 2210. Cache memories are typically organized into multiple levels depending upon relative proximity to the processing circuitry. Alternatively, some, or all, of the cache for the processor set can be located “off chip.” In some computing environments, processor set 2210 can be designed for working with qubits and performing quantum computing.

Computer readable program instructions are typically loaded onto computer 2201 to cause a series of operational steps to be performed by processor set 2210 of computer 2201 and thereby effect a computer-implemented method, such that the instructions thus executed will instantiate the methods specified in flowcharts or narrative descriptions of computer-implemented methods included in this document (collectively referred to as “the inventive methods”). These computer readable program instructions are stored in various types of computer readable storage media, such as cache 2221 and the other storage media discussed below. The program instructions, and associated data, are accessed by processor set 2210 to control and direct performance of the inventive methods. In computing environment 2200, at least some of the instructions for performing the inventive methods can be stored in block 2280 in persistent storage 2213.

COMMUNICATION FABRIC 2211 is the signal conduction path that allows the various components of computer 2201 to communicate with each other. Typically, this fabric is made of switches and electrically conductive paths, such as the switches and electrically conductive paths that make up busses, bridges, physical input/output ports and the like. Other types of signal communication paths can be used, such as fiber optic communication paths or wireless communication paths.

VOLATILE MEMORY 2212 is any type of volatile memory now known or to be developed in the future. Examples include dynamic type random access memory (RAM) or static type RAM. Typically, the volatile memory is characterized by random access, but this is not required unless affirmatively indicated. In computer 2201, the volatile memory 2212 is located in a single package and is internal to computer 2201, but, alternatively or additionally, the volatile memory can be distributed over multiple packages or located externally with respect to computer 2201.

PERSISTENT STORAGE 2213 is any form of non-volatile storage for computers that is now known or to be developed in the future. The non-volatility of this storage means that the stored data is maintained regardless of whether power is being supplied to computer 2201 or directly to persistent storage 2213. Persistent storage 2213 can be a read only memory (ROM), but typically at least a portion of the persistent storage allows writing of data, deletion of data and re-writing of data. Some familiar forms of persistent storage include magnetic disks and solid-state storage devices. Operating system 2222 can take several forms, such as various known proprietary operating systems or open-source Portable Operating System Interface type operating systems that employ a kernel. The code included in block 2280 typically includes at least some of the computer code involved in performing the inventive methods.

PERIPHERAL DEVICE SET 2214 includes the set of peripheral devices of computer 2201. Data communication connections between the peripheral devices and the other components of computer 2201 can be implemented in various ways, such as Bluetooth connections, Near-Field Communication (NFC) connections, connections made by cables (such as universal serial bus (USB) type cables), insertion type connections (for example, secure digital (SD) card), connections made though local area communication networks and even connections made through wide area networks such as the internet. In various embodiments, UI device set 2223 can include components such as a display screen, speaker, microphone, wearable devices (such as goggles and smart watches), keyboard, mouse, printer, touchpad, game controllers, and haptic devices. Storage 2224 is external storage, such as an external hard drive, or insertable storage, such as an SD card. Storage 2224 can be persistent or volatile. In some embodiments, storage 2224 can take the form of a quantum computing storage device for storing data in the form of qubits. In embodiments where computer 2201 is required to have a large amount of storage (for example, where computer 2201 locally stores and manages a large database) then this storage can be provided by peripheral storage devices designed for storing large amounts of data, such as a storage area network (SAN) that is shared by multiple, geographically distributed computers. IoT sensor set 2225 is made up of sensors that can be used in Internet of Things applications. For example, one sensor can be a thermometer and another sensor can be a motion detector.

NETWORK MODULE 2215 is the collection of computer software, hardware, and firmware that allows computer 2201 to communicate with other computers through WAN 2202. Network module 2215 can include hardware, such as modems or Wi-Fi signal transceivers, software for packetizing or de-packetizing data for communication network transmission, or web browser software for communicating data over the internet. In some embodiments, network control functions and network forwarding functions of network module 2215 are performed on the same physical hardware device. In other embodiments (for example, embodiments that utilize software-defined networking (SDN)), the control functions and the forwarding functions of network module 2215 are performed on physically separate devices, such that the control functions manage several different network hardware devices. Computer readable program instructions for performing the inventive methods can typically be downloaded to computer 2201 from an external computer or external storage device through a network adapter card or network interface included in network module 2215.

WAN 2202 is any wide area network (for example, the internet) capable of communicating computer data over non-local distances by any technology for communicating computer data, now known or to be developed in the future. In some embodiments, the WAN can be replaced or supplemented by local area networks (LANs) designed to communicate data between devices located in a local area, such as a Wi-Fi network. The WAN or LANs typically include computer hardware such as copper transmission cables, optical transmission fibers, wireless transmission, routers, firewalls, switches, gateway computers and edge servers.

END USER DEVICE (EUD) 2203 is any computer system that is used and controlled by an end user (for example, a customer of an enterprise that operates computer 2201) and can take any of the forms discussed above in connection with computer 2201. EUD 2203 typically receives helpful and useful data from the operations of computer 2201. For example, in a hypothetical case where computer 2201 is designed to provide a recommendation to an end user, this recommendation would typically be communicated from network module 2215 of computer 2201 through WAN 2202 to EUD 2203. In this way, EUD 2203 can display, or otherwise present, the recommendation to an end user. In some embodiments, EUD 2203 can be a client device, such as thin client, heavy client, mainframe computer or desktop computer.

REMOTE SERVER 2204 is any computer system that serves at least some data or functionality to computer 2201. Remote server 2204 can be controlled and used by the same entity that operates computer 2201. Remote server 2204 represents the machine(s) that collect and store helpful and useful data for use by other computers, such as computer 2201. For example, in a hypothetical case where computer 2201 is designed and programmed to provide a recommendation based on historical data, then this historical data can be provided to computer 2201 from remote database 2230 of remote server 2204.

PUBLIC CLOUD 2205 is any computer system available for use by multiple entities that provides on-demand availability of computer system resources or other computer capabilities, especially data storage (cloud storage) and computing power, without direct active management by the scale. The direct and active management of the computing resources of public cloud 2205 is performed by the computer hardware or software of cloud orchestration module 2241. The computing resources provided by public cloud 2205 are typically implemented by virtual computing environments that run on various computers making up the computers of host physical machine set 2242, which is the universe of physical computers in or available to public cloud 2205. The virtual computing environments (VCEs) typically take the form of virtual machines from virtual machine set 2243 or containers from container set 2244. It is understood that these VCEs can be stored as images and can be transferred among and between the various physical machine hosts, either as images or after instantiation of the VCE. Cloud orchestration module 2241 manages the transfer and storage of images, deploys new instantiations of VCEs and manages active instantiations of VCE deployments. Gateway 2240 is the collection of computer software, hardware and firmware allowing public cloud 2205 to communicate through WAN 2202.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 2206 is similar to public cloud 2205, except that the computing resources are only available for use by a single enterprise. While private cloud 2206 is depicted as being in communication with WAN 2202, in other embodiments a private cloud can be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, or data/application portability between the multiple constituent clouds. In this embodiment, public cloud 2205 and private cloud 2206 are both part of a larger hybrid cloud.

The embodiments described herein can be directed to one or more of a system, a method, an apparatus or a computer program product at any possible technical detail level of integration. The computer program product can include a computer readable storage medium (or media) having computer readable program instructions thereon for causing a processor to carry out aspects of the one or more embodiments described herein. The computer readable storage medium can be a tangible device that can retain and store instructions for use by an instruction execution device. The computer readable storage medium can be, for example, but is not limited to, an electronic storage device, a magnetic storage device, an optical storage device, an electromagnetic storage device, a superconducting storage device or any suitable combination of the foregoing. A non-exhaustive list of more specific examples of the computer readable storage medium can also include the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon or any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network or a wireless network. The network can comprise copper transmission cables, optical transmission fibers, wireless transmission, routers, firewalls, switches, gateway computers or edge servers. A network adapter card or network interface in each computing/processing device receives computer readable program instructions from the network and forwards the computer readable program instructions for storage in a computer readable storage medium within the respective computing/processing device. Computer readable program instructions for carrying out operations of the one or more embodiments described herein can be assembler instructions, instruction-set-architecture (ISA) instructions, machine instructions, machine dependent instructions, microcode, firmware instructions, state-setting data, configuration data for integrated circuitry, or source code or object code written in any combination of one or more programming languages, including an object oriented programming language such as Smalltalk, C++ or the like, or procedural programming languages, such as the “C” programming language or similar programming languages. The computer readable program instructions can execute entirely on a computer, partly on a computer, as a stand-alone software package, partly on a computer or partly on a remote computer or entirely on the remote computer or server. In the latter scenario, the remote computer can be connected to a computer through any type of network, including a local area network (LAN) or a wide area network (WAN), or the connection can be made to an external computer (for example, through the Internet using an Internet Service Provider). In one or more embodiments, electronic circuitry including, for example, programmable logic circuitry, field-programmable gate arrays (FPGA) or programmable logic arrays (PLA) can execute the computer readable program instructions by utilizing state information of the computer readable program instructions to personalize the electronic circuitry, in order to perform aspects of the one or more embodiments described herein.

Aspects of the one or more embodiments described herein are described with reference to flowchart illustrations or block diagrams of methods, apparatus (systems), and computer program products according to one or more embodiments described herein. It will be understood that each block of the flowchart illustrations or block diagrams, and combinations of blocks in the flowchart illustrations or block diagrams, can be implemented by computer readable program instructions. These computer readable program instructions can be provided to a processor of a general-purpose computer, special purpose computer or other programmable data processing apparatus to produce a machine, such that the instructions, which execute via the processor of the computer or other programmable data processing apparatus, can create means for implementing the functions/acts specified in the flowchart or block diagram block or blocks. These computer readable program instructions can also be stored in a computer readable storage medium that can direct a computer, a programmable data processing apparatus or other devices to function in a particular manner, such that the computer readable storage medium having instructions stored therein can comprise an article of manufacture including instructions which can implement aspects of the function/act specified in the flowchart or block diagram block or blocks. The computer readable program instructions can also be loaded onto a computer, other programmable data processing apparatus or other device to cause a series of operational acts to be performed on the computer, other programmable apparatus or other device to produce a computer implemented process, such that the instructions which execute on the computer, other programmable apparatus or other device implement the functions/acts specified in the flowchart or block diagram block or blocks.

The flowcharts and block diagrams in the figures illustrate the architecture, functionality or operation of possible implementations of systems, computer-implementable methods or computer program products according to one or more embodiments described herein. In this regard, each block in the flowchart or block diagrams can represent a module, segment or portion of instructions, which comprises one or more executable instructions for implementing the specified logical function. In one or more alternative implementations, the functions noted in the blocks can occur out of the order noted in the Figures. For example, two blocks shown in succession can be executed substantially concurrently, or the blocks can sometimes be executed in the reverse order, depending upon the functionality involved. It will also be noted that each block of the block diagrams or flowchart illustration, or combinations of blocks in the block diagrams or flowchart illustration, can be implemented by special purpose hardware-based systems that can perform the specified functions or acts or carry out one or more combinations of special purpose hardware or computer instructions.

While the subject matter has been described above in the general context of computer-executable instructions of a computer program product that runs on a computer or computers, those skilled in the art will recognize that the one or more embodiments herein also can be implemented at least partially in parallel with one or more other program modules. Generally, program modules include routines, programs, components or data structures that perform particular tasks or implement particular abstract data types. Moreover, the aforedescribed computer-implemented methods can be practiced with other computer system configurations, including single-processor or multiprocessor computer systems, mini-computing devices, mainframe computers, as well as computers, hand-held computing devices (e.g., PDA, phone), or microprocessor-based or programmable consumer or industrial electronics. The illustrated aspects can also be practiced in distributed computing environments in which tasks are performed by remote processing devices that are linked through a communications network. However, one or more, if not all aspects of the one or more embodiments described herein can be practiced on stand-alone computers. In a distributed computing environment, program modules can be located in both local and remote memory storage devices.

As used in this application, the terms “component,” “system,” “platform” or “interface” can refer to or can include a computer-related entity or an entity related to an operational machine with one or more specific functionalities. The entities described herein can be either hardware, a combination of hardware and software, software, or software in execution. For example, a component can be, but is not limited to being, a process running on a processor, a processor, an object, an executable, a thread of execution, a program or a computer. By way of illustration, both an application running on a server and the server can be a component. One or more components can reside within a process or thread of execution and a component can be localized on one computer or distributed between two or more computers. In another example, respective components can execute from various computer readable media having various data structures stored thereon. The components can communicate via local or remote processes such as in accordance with a signal having one or more data packets (e.g., data from one component interacting with another component in a local system, distributed system or across a network such as the Internet with other systems via the signal). As another example, a component can be an apparatus with specific functionality provided by mechanical parts operated by electric or electronic circuitry, which is operated by a software or firmware application executed by a processor. In such a case, the processor can be internal or external to the apparatus and can execute at least a part of the software or firmware application. As yet another example, a component can be an apparatus that provides specific functionality through electronic components without mechanical parts, where the electronic components can include a processor or other means to execute software or firmware that confers at least in part the functionality of the electronic components. In an aspect, a component can emulate an electronic component via a virtual machine, e.g., within a cloud computing system.

In addition, the term “or” is intended to mean an inclusive “or” rather than an exclusive “or.” That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. As used herein, the term “and/or” is intended to have the same meaning as “or.” Moreover, articles “a” and “an” as used in the subject specification and annexed drawings should generally be construed to mean “one or more” unless specified otherwise or clear from context to be directed to a singular form. As used herein, the terms “example” or “exemplary” are utilized to mean serving as an example, instance, or illustration. For the avoidance of doubt, the subject matter described herein is not limited by such examples. In addition, any aspect or design described herein as an “example” or “exemplary” is not necessarily to be construed as preferred or advantageous over other aspects or designs, nor is it meant to preclude equivalent exemplary structures and techniques known to those of ordinary skill in the art.

The herein disclosure describes non-limiting examples of various embodiments. For ease of description or explanation, various portions of the herein disclosure utilize the term “each”, “every”, or “all” when discussing various embodiments. Such usages of the term “each”, “every”, or “all” are non-limiting examples. In other words, when the herein disclosure provides a description that is applied to “each”, “every”, or “all” of some particular object or component, it should be understood that this is a non-limiting example of various embodiments, and it should be further understood that, in various other embodiments, it can be the case that such description applies to fewer than “each”, “every”, or “all” of that particular object or component.

As it is employed in the subject specification, the term “processor” can refer to substantially any computing processing unit or device comprising, but not limited to, single-core processors; single-processors with software multithread execution capability; multi-core processors; multi-core processors with software multithread execution capability; multi-core processors with hardware multithread technology; parallel platforms; or parallel platforms with distributed shared memory. Additionally, a processor can refer to an integrated circuit, an application specific integrated circuit (ASIC), a digital signal processor (DSP), a field programmable gate array (FPGA), a programmable logic controller (PLC), a complex programmable logic device (CPLD), a discrete gate or transistor logic, discrete hardware components, or any combination thereof designed to perform the functions described herein. Further, processors can exploit nano-scale architectures such as, but not limited to, molecular and quantum-dot based transistors, switches or gates, in order to optimize space usage or to enhance performance of related equipment. A processor can be implemented as a combination of computing processing units.

Herein, terms such as “store,” “storage,” “data store,” data storage,” “database,” and substantially any other information storage component relevant to operation and functionality of a component are utilized to refer to “memory components,” entities embodied in a “memory,” or components comprising a memory. Memory or memory components described herein can be either volatile memory or nonvolatile memory or can include both volatile and nonvolatile memory. By way of illustration, and not limitation, nonvolatile memory can include read only memory (ROM), programmable ROM (PROM), electrically programmable ROM (EPROM), electrically erasable ROM (EEPROM), flash memory or nonvolatile random-access memory (RAM) (e.g., ferroelectric RAM (FeRAM). Volatile memory can include RAM, which can act as external cache memory, for example. By way of illustration and not limitation, RAM can be available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), direct Rambus RAM (DRRAM), direct Rambus dynamic RAM (DRDRAM) or Rambus dynamic RAM (RDRAM). Also, the described memory components of systems or computer-implemented methods herein are intended to include, without being limited to including, these or any other suitable types of memory.

What has been described above includes mere examples of systems and computer-implemented methods. It is, of course, not possible to describe every conceivable combination of components or computer-implemented methods for purposes of describing the one or more embodiments, but one of ordinary skill in the art can recognize that many further combinations or permutations of the one or more embodiments are possible. Furthermore, to the extent that the terms “includes,” “has,” “possesses,” and the like are used in the detailed description, claims, appendices or drawings such terms are intended to be inclusive in a manner similar to the term “comprising” as “comprising” is interpreted when employed as a transitional word in a claim.

The descriptions of the various embodiments have been presented for purposes of illustration but are not intended to be exhaustive or limited to the embodiments described herein. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments described herein.

What is claimed is:

1. A system, comprising:
a processor that executes computer-executable components stored in a non-transitory computer-readable memory, the computer-executable components comprising:
an access component that accesses a graph; and
a training component that trains a graph neural network on partitions of the graph, based on historical gradients of partition-wise training losses with respect to one-hop node embeddings.

2. The system of claim 1, wherein a first partition of the graph and a second partition of the graph have a one-hop node, wherein the one-hop node corresponds to an historical gradient value and to an historical gradient count, wherein the historical gradient value is initially zero, and wherein the historical gradient count is initially zero.

3. The system of claim 2, wherein, while training the graph neural network on the first partition, the training component:
adds to the historical gradient value of the one-hop node a gradient of a first loss of the first partition with respect to a first embedding of the one-hop node; and
increments the historical gradient count.

4. The system of claim 3, wherein, while training the graph neural network on the second partition, the training component:
adds to the historical gradient value a gradient of a second loss of the second partition with respect to a second embedding of the one-hop node; and
increments the historical gradient count.

5. The system of claim 4, wherein, while training the graph neural network on a third partition to which the one-hop node belongs, the training component:
updates the graph neural network based on a third loss of the third partition and based on a product between the historical gradient value and a reciprocal of the historical gradient count.

6. The system of claim 5, wherein the training component:
resets the historical gradient value to zero and the historical gradient count to zero, in response to updating the graph neural network based on the third loss.

7. The system of claim 1, wherein the partitions of the graph are disjoint.

8. The system of claim 1, wherein the partitions of the graph are overlapping.

9. The system of claim 1, wherein the computer-executable components comprise:
an execution component that executes, post-training, the graph neural network on another graph, thereby yielding an inferencing task result for the another graph.

10. A computer-implemented method, comprising:
accessing, by a device operatively coupled to a processor, a graph; and
training, by the device, a graph neural network on partitions of the graph, based on historical gradients of partition-wise training losses with respect to one-hop node embeddings.

11. The computer-implemented method of claim 10, wherein a first partition of the graph and a second partition of the graph have a one-hop node, wherein the one-hop node corresponds to an historical gradient value and to an historical gradient count, wherein the historical gradient value is initially zero, and wherein the historical gradient count is initially zero.

12. The computer-implemented method of claim 11, wherein, while training the graph neural network on the first partition, the device:
adds to the historical gradient value of the one-hop node a gradient of a first loss of the first partition with respect to a first embedding of the one-hop node; and
increments the historical gradient count.

13. The computer-implemented method of claim 12, wherein, while training the graph neural network on the second partition, the device:
adds to the historical gradient value a gradient of a second loss of the second partition with respect to a second embedding of the one-hop node; and
increments the historical gradient count.

14. The computer-implemented method of claim 13, wherein, while training the graph neural network on a third partition to which the one-hop node belongs, the device:
updates the graph neural network based on a third loss of the third partition and based on a product between the historical gradient value and a reciprocal of the historical gradient count.

15. The computer-implemented method of claim 14, wherein the device:
resets the historical gradient value to zero and the historical gradient count to zero, in response to updating the graph neural network based on the third loss.

16. The computer-implemented method of claim 10, wherein the partitions of the graph are disjoint.

17. The computer-implemented method of claim 10, wherein the partitions of the graph are overlapping.

18. The computer-implemented method of claim 10, further comprising:
executing, by the device and post-training, the graph neural network on another graph, thereby yielding an inferencing task result for the another graph.

19. A computer program product for facilitating partitioned training via one-hop historical gradients, the computer program product comprising a non-transitory computer-readable memory having program instructions embodied therewith, the program instructions executable by a processor to cause the processor to:
access a graph; and
train a graph neural network on partitions of the graph, based on historical gradients of partition-wise training losses with respect to one-hop node embeddings or based on gradients of in-partition node embeddings with respect to learnable parameters of the graph neural network.

20. The computer program product of claim 19, wherein the program instructions are further executable to cause the processor to:
execute, post-training, the graph neural network on another graph, thereby yielding an inferencing task result for the another graph.
